(19) United States
(12) Patent Application Publication
(10) Pub. No.: US 2026/0122111 A1
(43) Pub. Date: Apr. 30, 2026

(54) MULTI-LAYERED RISK MITIGATION SYSTEM

(71) Applicant: ROYAL BANK OF CANADA, Toronto (CA)

(72) Inventors: Salah SHARIEH, Toronto (CA); Evgenii OSTANIN, Toronto (CA); Brett NOYE, Toronto (CA); Paula DUZI, Toronto (CA); Fatima Javaid HUSSAIN, Toronto (CA); Andrea RICCI, Toronto (CA); Nebojsa DJOSIC, Toronto (CA); Milos STOJADINOVIC, Toronto (CA); Moussa NOUN, Toronto (CA)

(21) Appl. No.: 19/375,750

(22) Filed: Oct. 31, 2025

Related U.S. Application Data
(60) Provisional application No. 63/714,473, filed on Oct. 31, 2024.
(60) Provisional application No. 63/714,479, filed on Oct. 31, 2024.
(60) Provisional application No. 63/714,488, filed on Oct. 31, 2024.
(60) Provisional application No. 63/714,494, filed on Oct. 31, 2024.

(51) Int. Cl. H04L 9/40

(52) U.S. Cl. CPC H04L 63/20; H04L 63/1433

(57) ABSTRACT

There is provided a multi-layered risk mitigation system. The system may receive TCP packets and/or TCP streams in real-time and process packets. Packets may be enriched with metadata and additional data. A real-time risk score may be subsequently calculated using ensembles of machine learning models trained using narrow, focused datasets. Domain dataset attributes may be asynchronously analyzed and refreshed as new packets are received. ML models may be continually updated and/or refreshed. Layers of controls may be added or removed depending on the determined level of risk to dynamically balance processing efficiency with performance.

### CROSS-REFERENCE TO RELATED APPLICATIONS

This claims the benefit of, and priority to, U.S. Provisional Patent Application Nos. 63/714,473, 63/714,479, 63/714,488, and 63/714,494, each filed Oct. 31, 2024, the entire contents of which are incorporated herein by reference.

### FIELD

This relates generally to computer-implemented cybersecurity systems, and in particular to cybersecurity systems comprising multiple layers.

### BACKGROUND

The use of computerized systems and software has become ubiquitous throughout organizations. In many organizations, the use of third party Software-as-a-Service (SaaS) applications (i.e., SaaS applications which are created and administered external to an organization) is becoming increasingly common, as modern communications systems have overcome bandwidth limitations which might have limited the utility of such SaaS applications and vendor and contractor services in the past. Moreover, an increasing number of vendors have shifted to only offering SaaS and remote distribution models.

There are a number of challenges inherent with the use of third party vendors, contractors, and SaaS applications for an organization. Among the most important challenges are governance, regulatory compliance and Data Leak Prevention (DLP). Data leakage is distinguished from data loss, in that data loss most commonly refers to data being destroyed due to hardware failure, natural disasters, accidental or intention destruction, adversarial (e.g. ransom) attacks, and the like.

Contrastingly, data leakage refers to events, incidents and processes by which an unauthorized party or parties gain access to data. In the case of data leakage, data is not typically lost, but is instead made available to parties that should not be authorized to have access to it. Making certain types of data available to unauthorized parties is, in many jurisdictions, unlawful in and of itself, regardless of whether the data has in fact been accessed those unauthorized parties. In addition, there are regulatory requirements related to DLP which are becoming increasingly strict. It is important for organizations to detect data leakage in order to collect consent, acknowledgments, terms and conditions, and collect and report metadata related to legitimate data access and sharing with third parties.

With the advent of generative artificial intelligence (AI or “genAI”), there is enormous potential for increased efficiency and effectiveness within an organization, but it is challenging for an organization to make generative AI-enabled Software-as-a-Service (SaaS) applications available to employees in a secure manner. Moreover, it is challenging for an organization to govern access to generative AI SaaS applications.

Such challenges include initially evaluating and providing access to genAI-enabled SaaS applications in accordance with rules, regulations, and policies, and also for continuously evaluating compliance with such rules, regulations and policies. The laws, rules, regulations, and policies governing generative AI SaaS applications, as well as technologies and practices, are evolving at an ever-increasing pace. In such an environment, it is important to implement highly flexible, configurable, automated controls that enable organizations to make dynamic changes in real-time or near real-time.

Failing to adequately monitor and control access to generative AI SaaS applications may result in data leakage and/or non-compliance. As such, there is a growing need to accurately and dynamically determine potential risk exposure in real-time for each instance of access to SaaS applications based on the access request. Moreover, there is a need for an automated computing system and corresponding methods which may address the above-noted challenges.

### SUMMARY

In some embodiments, there is provided an automated, multi-layered computing system and method. Some embodiments may be configured to dynamically introduce and modify protection layers based on real-time processing of data in transit. Some embodiments may be highly flexible, dynamic, interactive, and/or configurable. Some embodiments are based on in-depth protection strategies comprising many light-weight, dynamic protection layers, with the capability of adding and removing protection layers depending on the output of other (e.g., previous) layers.

Some embodiments are configured to execute on standard hardware and in standard-size containers (e.g., Docker containers). As such, some embodiments may be suitable for execution in regular hyperscaler environments (e.g., Amazon Web Services (AWS), Azure, Google Cloud, and the like).

Some embodiments described herein may be more efficient than currently-available, monolithic, all-in-one systems such as Endpoint (Threat) Detection and Response (EDR) and Endpoint Protection Platforms (EPP). The conventional real-time protection provided by EDR and EPP is similar to malware and virus protections on personal computers, which function by blocking access. Contrastingly, some embodiments described herein may offer a wider range of options to the user and organizations deploying the system. Some of these options may include, but are not limited to, various warnings, such as a) regulation-mandated warnings (e.g., warnings of changes made to SaaS application terms and conditions and/or privacy), b) blocking access based on data being transmitted, c) requesting additional authorization (whether in the form of elevated authorization, or secondary authorization), acknowledgment, and/or acceptance of an organization's specific terms and conditions, privacy warnings, and the like.

In some embodiments, the above-noted options may be dynamic and may vary depending on the SaaS application being accessed, the method being used to access the SaaS application, and the data being exchanged. In this manner, some embodiments may aid organizations with regulatory governance, compliance, and enforcement of policies and procedures in addition to preventing data leakage.

In accordance with an aspect, there is provided a system, comprising: one or more processors; a non-transitory computer-readable storage medium having stored thereon processor-executable instructions that, when executed by said one or more processors, cause said one or more processors to perform a method of providing a multi-layered protection and mitigation system, the method comprising: receiving, within a private network, one or more network data packets comprising a request to access a resource external to said private network; processing, by a risk exposure evaluation and mitigation subsystem within said private network, said one or more network packets to determine an anomaly score; determining, by a risk exposure scoring subsystem within said private network, a risk score for one or more network data packets using one or more ensembles of ML models; determining whether said one or more network data packets exhibits anomalous behavior based on said real-time risk score; determining a mitigation action based on said real-time risk score; implementing said mitigation action at a policy enforcement point within said private network.

In accordance with another aspect, there is provided a method of providing a multi-layered protection and mitigation system, the method comprising: receiving, within a private network, one or more network data packets comprising a request to access a resource external to said private network; processing, by a risk exposure evaluation and mitigation subsystem within said private network, said one or more network packets to determine an anomaly score; determining, by a risk exposure scoring subsystem within said private network, a risk score for one or more network data packets using one or more ensembles of ML models; determining whether said one or more network data packets exhibits anomalous behavior based on said real-time risk score; determining a mitigation action based on said real-time risk score; implementing said mitigation action at a policy enforcement point within said private network.

In accordance with still another aspect, there is provided a non-transitory computer-readable storage medium having stored thereon processor-executable instructions that, when executed by one or more processors, cause the one or more processors to perform a method of providing a multi-layered protection and mitigation system, the method comprising: receiving, within a private network, one or more network data packets comprising a request to access a resource external to said private network; processing, by a risk exposure evaluation and mitigation subsystem within said private network, said one or more network packets to determine an anomaly score; determining, by a risk exposure scoring subsystem within said private network, a risk score for one or more network data packets using one or more ensembles of ML models; determining whether said one or more network data packets exhibits anomalous behavior based on said real-time risk score; determining a mitigation action based on said real-time risk score; implementing said mitigation action at a policy enforcement point within said private network.

In accordance with still another aspect, there is provided a method of providing a risk exposure evaluation and mitigation system, the method comprising: receiving, within a private network, one or more network data packets comprising a request to access a resource external to said private network; extracting, by a risk exposure evaluation and mitigation subsystem within said private network, metadata from said received one or more network data packets; identifying, by said risk exposure evaluation and mitigation subsystem, at least one of a user and/or a device associated with said one or more network data packets; determining whether to flag said one or more network data packets as being anomalous; and flagging said one or more network data packets based on said determination.

In accordance with still another aspect, there is provided a system comprising: one or more processors; a non-transitory computer-readable medium having stored thereon processor-executable instructions that, when executed by said one or more processors, cause said one or more processors to perform a method of providing a risk exposure evaluation and mitigation system, the method comprising: receiving, within a private network, one or more network data packets comprising a request to access a resource external to said private network; extracting, by a risk exposure evaluation and mitigation subsystem within said private network, metadata from said received one or more network data packets; identifying, by said risk exposure evaluation and mitigation subsystem, at least one of a user and/or a device associated with said one or more network data packets; determining whether to flag said one or more network data packets as being anomalous; and flagging said one or more network data packets based on said determination.

In accordance with still another aspect, there is provided a non-transitory computer-readable medium having stored thereon processor-executable instructions that, when executed by one or more processors, cause said one or more processors to perform a method of providing a risk exposure evaluation and mitigation system, the method comprising: receiving, within a private network, one or more network data packets comprising a request to access a resource external to said private network; extracting, by a risk exposure evaluation and mitigation subsystem within said private network, metadata from said received one or more network data packets; identifying, by said risk exposure evaluation and mitigation subsystem, at least one of a user and/or a device associated with said one or more network data packets; determining whether to flag said one or more network data packets as being anomalous; and flagging said one or more network data packets based on said determination.

In accordance with still another aspect, there is provided a method for determining a risk level associated with network data packets in a private network, the method comprising: receiving one or more network data packets intended for transmission from a computing device in said private network to a destination device external to said private network, said one or network data packets being enriched with metadata and supplementary data; selecting one or more sets of machine learning (ML) models to evaluate said one or more network data packets, each of said sets of ML models being trained based on one or more features of network data packets, said metadata and said supplementary data; processing said one or more network data packets using said selected one or more sets of ML models, wherein each of said one or more sets of ML models processes a respective one of said one or more network data packets in parallel; storing outputs of said processing in a database; and determining a risk score for said one or more network data packets using each of said selected ML models.

In accordance with still another aspect, there is provided a system comprising: one or more processors; a non-transitory computer-readable storage medium having stored thereon processor-executable instructions that, when executed by said one or more processors, cause said one or more processors to perform a method for determining a risk level associated with network data packets in a private network, the method comprising: receiving one or more network data packets intended for transmission from a computing device in said private network to a destination device external to said private network, said one or network data packets being enriched with metadata and supplementary data; selecting one or more sets of machine learning (ML) models to evaluate said one or more network data packets, each of said sets of ML models being trained based on one or more features of network data packets, said metadata and said supplementary data; processing said one or more network data packets using said selected one or more sets of ML models, wherein each of said one or more sets of ML models processes a respective one of said one or more network data packets in parallel; storing outputs of said processing in a database; and determining a risk score for said one or more network data packets using each of said selected ML models.

In accordance with still another aspect, there is provided a non-transitory computer-readable storage medium having stored thereon processor-executable instructions that, when executed by one or more processors, cause said one or more processors to perform a method for determining a risk level associated with network data packets in a private network, the method comprising: receiving one or more network data packets intended for transmission from a computing device in said private network to a destination device external to said private network, said one or network data packets being enriched with metadata and supplementary data; selecting one or more sets of machine learning (ML) models to evaluate said one or more network data packets, each of said sets of ML models being trained based on one or more features of network data packets, said metadata and said supplementary data; processing said one or more network data packets using said selected one or more sets of ML models, wherein each of said one or more sets of ML models processes a respective one of said one or more network data packets in parallel; storing outputs of said processing in a database; and determining a risk score for said one or more network data packets using each of said selected ML models.

In accordance with still another aspect, there is provided a method of evaluating risk exposure, the method comprising: receiving, at a risk exposure subsystem within a private network, a network data packet comprising a destination Uniform Resource Locator (URL) domain external to the private network; obtaining one or more documents from said URL domain based on a configuration; extracting, from said one or more obtained documents, content relevant to said configuration; obtaining data relating to said URL domain; generating a dataset comprising a plurality of attributes; and determining a set of compliance controls for at least one of mitigating risk and/or ensuring regulatory compliance.

In accordance with still another aspect, there is provided a system comprising: one or more processors; a non-transitory computer-readable storage medium having stored thereon computer-executable instructions that, when executed by said one or more processors, cause said one or more processors to perform a method of evaluating risk exposure, the method comprising: receiving, at a risk exposure subsystem within a private network, a network data packet comprising a destination Uniform Resource Locator (URL) domain external to the private network; obtaining one or more documents from said URL domain based on a configuration; extracting, from said one or more obtained documents, content relevant to said configuration; obtaining data relating to said URL domain; generating a dataset comprising a plurality of attributes; and determining a set of compliance controls for at least one of mitigating risk and/or ensuring regulatory compliance.

In accordance with still another aspect, there is provided a non-transitory computer-readable storage medium having stored thereon computer-executable instructions that, when executed by one or more processors, cause the one or more processors to perform a method of evaluating risk exposure, the method comprising: receiving, at a risk exposure subsystem within a private network, a network data packet comprising a destination Uniform Resource Locator (URL) domain external to the private network; obtaining one or more documents from said URL domain based on a configuration; extracting, from said one or more obtained documents, content relevant to said configuration; obtaining data relating to said URL domain; generating a dataset comprising a plurality of attributes; and determining a set of compliance controls for at least one of mitigating risk and/or ensuring regulatory compliance.

Other features will become apparent from the drawings in conjunction with the following description.

### BRIEF DESCRIPTION OF DRAWINGS

In the figures which illustrate example embodiments,

FIG. 1 is a block diagram depicting components of an example computing system, in accordance with some embodiments;

FIG. 2 is a block diagram depicting components of an example computing device, in accordance with some embodiments;

FIG. 3 depicts a simplified arrangement of software at computing device;

FIG. 4 depicts a simplified high-level outgoing (egress) network application request data flow, in accordance with some embodiments;

FIG. 5 depicts a simplified high level placement and integration of an example embodiment within a network application dataflow and security system, in accordance with some embodiments;

FIG. 6 depicts a simplified risk score processing system and action determination workflow, in accordance with some embodiments;

FIG. 7 depicts a simplified continuous machine learning model and improvement workflow, in accordance with some embodiments;

FIG. 8 is a depiction of a dynamic security control system using multiple layers, in accordance with some embodiments;

FIG. 9 depicts a simplified workflow for request packet processing, in accordance with some embodiments;

FIG. 10 depicts a simplified workflow for data gathering for a request packet during processing, in accordance with some embodiments;

FIG. 11 depicts a simplified workflow for processing packets and generating a risk score, in accordance with some embodiments;

FIG. 12 depicts a simplified risk score calculation workflow, in accordance with some embodiments;

FIG. 13A depicts an ensemble of machine learning (ML) models trained using historical training data and/or a combination of historical training data and short-term trends;

FIG. 13B depicts an example rolling window;

FIG. 13C depicts an example workflow for training an ensemble of active-term ML models, in accordance with some embodiments;

FIG. 14 depicts an example timeline for continuous updates of various ML models, in accordance with some embodiments;

FIG. 15 depicts an example workflow for evaluation of a request, in accordance with some embodiments;

FIG. 16 depicts an example workflow for URL-domain processing, in accordance with some embodiments;

FIG. 17 depicts an example process for web page content downloading, in accordance with some embodiments;

FIG. 18 depicts an example process for data extraction and evaluation from downloaded content, in accordance with some embodiments;

FIG. 19 depicts an example process for calculating a risk score and ranking processes, in accordance with some embodiments; and

FIG. 20 is an illustration of various process flows for compliance control requirements, in accordance with some embodiments.

### DETAILED DESCRIPTION

In some embodiments, systems and methods described herein may allow administrators and/or other special groups of users to define and change configuration settings. Some embodiments may provide multi-layered protection and mitigation based on the so-called Swiss Cheese model for narrowly focused contexts, including but not limited to governance and compliance.

Some embodiments may process TCP packets in real-time to extract relevant metadata, keep track of TCP streams (connections), detect anomalies, and map TCP streams to users and devices. Some embodiments may further enrich extracted TCP metadata with other previously gathered data.

Some embodiments may provide a recommended mitigation action for a focused context (e.g., a governance and/or compliance context). Some embodiments may provide an Application Programming Interface (API) service to external systems to determine mitigation actions for focused contexts. Some embodiments may map internal user interactions with remote target servers using devices connected to remote target servers (and not connected to an internal network), keep track of TCP connections in real-time, and keep historical records of user, device, and remote target server interactions.

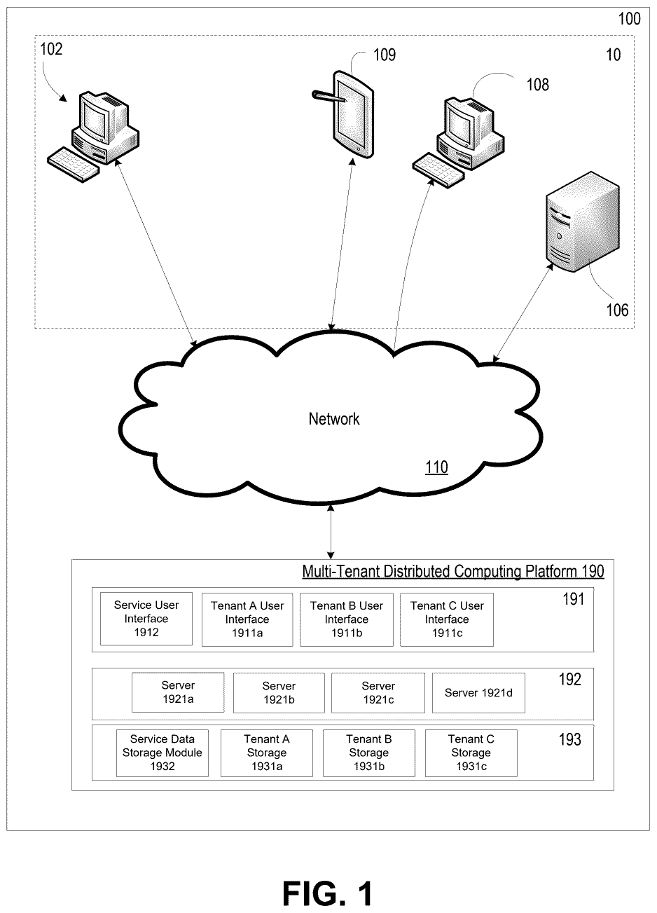

Various embodiments of the present invention may make use of interconnected computer networks and components. FIG. 1 is a block diagram depicting components of an example computing system 100. Components of the computing system are interconnected to define a multi-layered risk mitigation system. As used herein, the term “multi-layered risk mitigation system” refers to a combination of hardware devices configured under control of software and interconnections between such devices and software.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 118 such as a hard drive, an array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, a distributed computing platform 190 may include multiple processing layers, including a user interface layer 191, an application server layer 192, and a data storage layer 193.

In some embodiments, the user interface layer 191 may include a user interface (e.g., service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In some embodiments, the data storage layer 193 may include, for example, a data storage module 1932 for the service, as well as one or more tenant data storage modules 1931a, 1931b, 1931c which may contain tenant-specific data which is used in providing tenant-specific services or functions.

In some embodiments, platform 190 may be operated by a third party hyperscaler 490 (e.g., Amazon, Microsoft, Google, or the like) to provide multiple tenants with applications, data storage, and functionality. A multi-tenant system as depicted in FIG. 1 may include multiple different applications (e.g., multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

In some embodiments, systems such as multi-layered risk mitigation (MLRM) system 126 may be executed locally within organization 10, without requiring the extensive computing resources of distributed computing platform 190. This may be advantageous in that an organization may have full control over the design and architecture of MLRM system 126, as described herein.

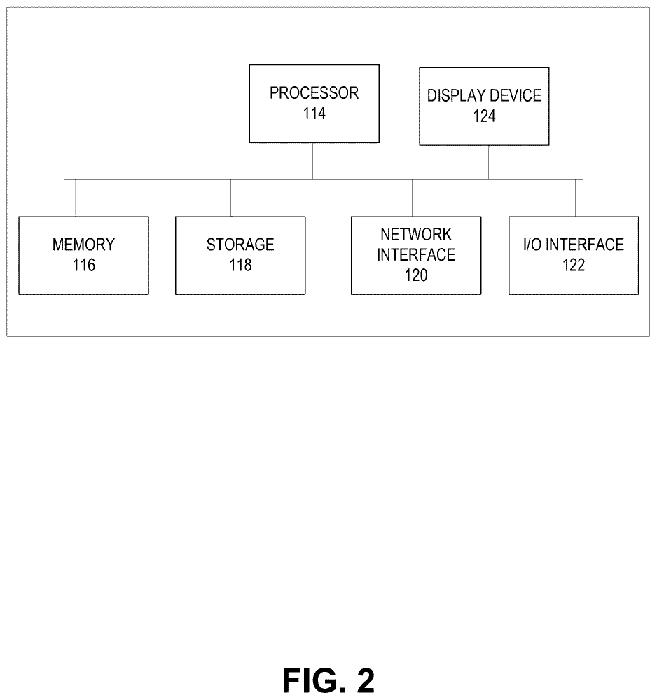

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third-party SaaS applications (e.g., SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using one or more processors 114.

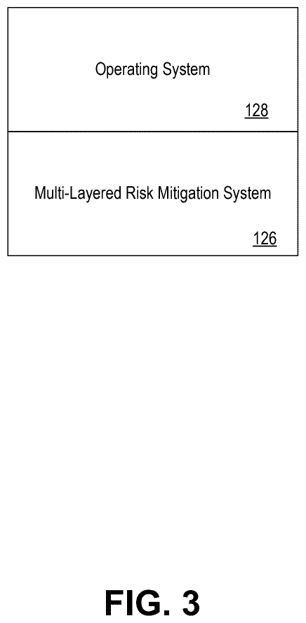

FIG. 3 depicts a simplified arrangement of software at an example computing device. The software may include an operating system 128 and application software, such as multi-layered risk mitigation system 126. It will be appreciated that in distributed computing environments, implementation, and administration of an application such as system 126 may be distributed amongst a plurality of separate computing devices within organization 10, and that FIG. 3 is intended to depict a simplified logical separation between an operating system 128 on an example computing device(s), and an application executing on the example computing device(s).

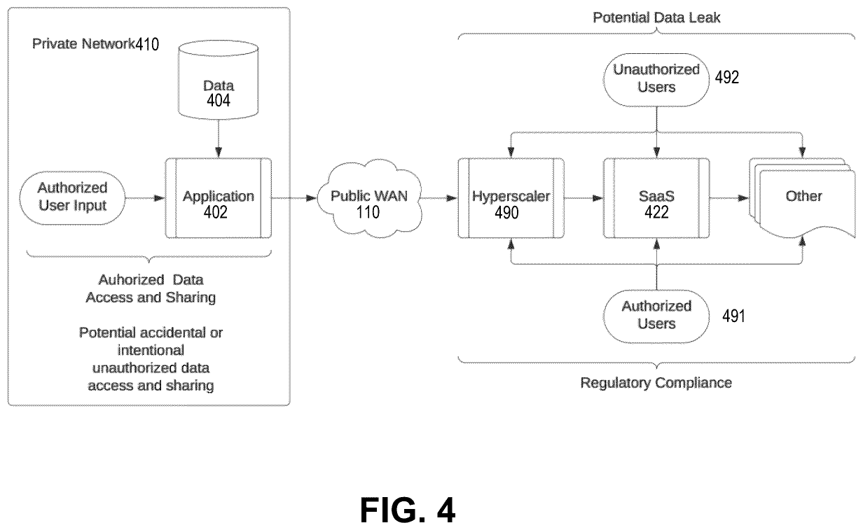

FIG. 4 depicts a simplified high-level outgoing (i.e., egress) network application request data flow, in accordance with some embodiments. The configuration depicted in FIG. 4 depicts a typical problem space for modern computing systems. Traditionally, an organization's private network 410 would protect data within the private network through authentication and authorization, and once data is accessed, the data typically remains within the private network 410 and/or within device which are under the control of the organization 10.

As depicted in FIG. 4, an application 402 executing on a computing device within private network 410 may generate a request which is transmitted to an external SaaS application 422 via network 110 (e.g., the internet) and hyperscaler 490. In some embodiments, the request may include private data 404. Because the request is being transmitted external to private network 410, organization 10's authentication and authorization safeguards might not reliably the protect data 404 included with the request. For example, when private data 404 is shared within private network 410, the private data is shared through applications in a manner which adhere to the patterns, data flows, and paths specified by the organization 10.

Contrastingly, the proliferation of SaaS applications 422 (and specifically with AI and Generative AI) may increase the risk that even authorized access by authorized users 491 to private data 404 may still unintentionally result in subsequent data leaks and unauthorized access by unauthorized users 492. For example, once private data 404 has left the organization 10 via public network 110, the organization 10 can no longer exercise the same degree of control over the private data 404. Some embodiments described herein relate to measures and controls which may be implemented prior to private data 404 exiting an organization's private network 410 control boundaries.

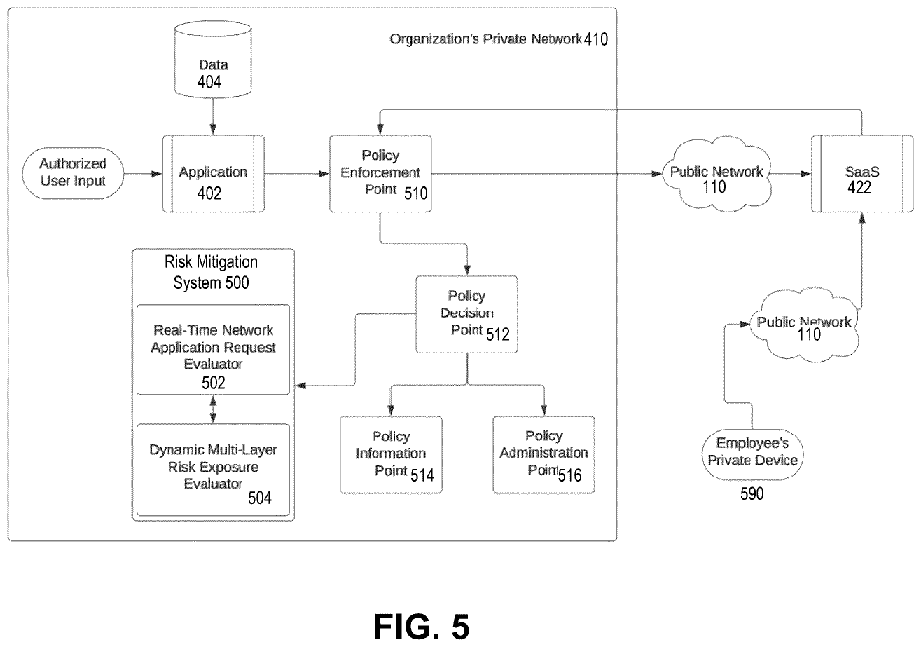

FIG. 5 depicts a simplified high-level network application data flow which incorporates an example multi-layered risk mitigation system 500, in accordance with some embodiments. In some embodiments, system 500 may be integrated with one or more of policy enforcement point (PEP) 510, policy decision point 512 (PDP), policy information point 514 (PIP), and policy administration point 516 (PAP).

In some embodiments, PEP 510 may receive network traffic data packets, inspect the network traffic data packets, and/or delegate the network traffic data packets to PDP 512. In some embodiments, PDP 512 determines what action, if any, should be taken with respect to network data packets. In some embodiments, PDP 512 may include information point 514 and/or policy administration point 516. In some embodiments, information point 514 contains and provides information about applications, users, and subjects. In some embodiments, policy administration point 516 contains and provides information and instructions relating to policy enforcement mechanisms and/or decisions. When network data packets are received at PEP 510, PEP 510 is configured to make one or more determinations relating to the network data packets. Some example determinations might include determining whether a data packet is from a registered user 491, whether the network traffic data packet is authorized, whether transmission of the data packet should be stopped, blocked, logged, and the like.

Typically, conventional policy enforcement subsystems such as PDP 512, PIP 514 and PAP 516 are static systems. For example, an organization's policy might be a rigid, blanket ban blocking access to a website (e.g., YouTube), with little to no granularity or flexibility. Such systems broadly consider network traffic data packets in the aggregate, without nuance, which is conceptually straightforward but not ideal in a practical context. For example, there may be a legitimate reason for a particular user to need to access a banned website.

Contrastingly, and advantageously, some embodiments described herein allow for significantly greater granularity in assessing what actions to take with network data packets. For example, in some embodiments, the mitigation system 500 depicted in FIG. 5 might include a real-time network application request evaluator 502 and/or a dynamic multi-layer risk exposure evaluator 504. In some embodiments, request evaluator 502 may be configured to consider data packets requesting access to a YouTube link and take into account one or more of the requesting user's job title, job role, job tasks, job description, and the like, to determine whether that particular user at that particular point in time should be allowed to proceed with gaining access. In some embodiments, the decision of risk mitigation system 500 is transmitted to policy decision point 512 and policy enforcement point 510. It will be appreciated that in some embodiments, the processing performed on data packets by risk mitigation system 500 may be performed prior to the data packet being allowed to leave organization 10's private network 410.

In this manner, an authorized user whose job role legitimately might require access to YouTube might be automatically allowed to proceed by request evaluator 502, whereas an employee whose job role lacks a legitimate reason for accessing YouTube might have their request blocked by request evaluator 502. Moreover, this determination may take into account the temporal nature of the network traffic data packets. For example, in some embodiments, network activity from as recent as the past hour may be taken into account by request evaluator 502 and risk exposure evaluator 504 in determining whether a particular activity warrants increased scrutiny or not. In some embodiments, mitigation system 500 may be updating its rule sets constantly so as to provide dynamic evaluations instead of static rules. Such granularity and nuance is not available in conventional systems.

In some embodiments, risk mitigation system 500 may be configured to be compliant with the National Institute of Standards and Technology (NIST) Digital Identity Guidelines for Federation and Assertions, and in particular with Federation Assertion Level (FAL) 1. In some embodiments, system 500 may be compliant with FALs 2 and 3, which require identity assertion encryption.

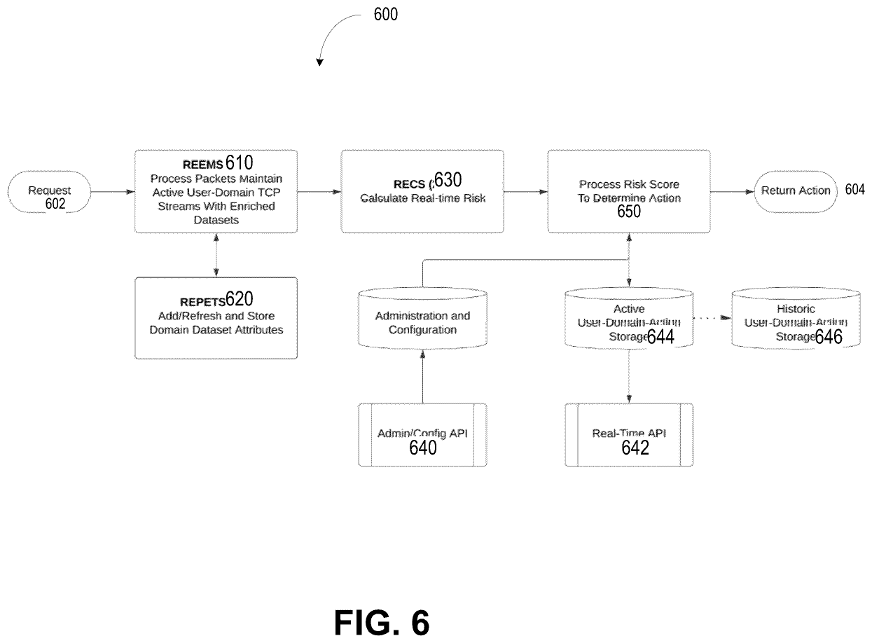

FIG. 6 depicts a simplified high-level network request processing flow by a risk mitigation system 500, in accordance with some embodiments. As depicted, Transmission Control Protocol (TCP) outgoing (egress) network data packets from private network 410 (denoted as request 602, because a user is requesting a response from a server external to private network 410) are transmitted to and/or processed by one or more data processing and evaluation subsystems of risk mitigation system 500. In some embodiments, the data processing and evaluation subsystems may include a Risk Exposure Evaluation and Mitigation System (REEMS) 610, Risk Exposure Potential Evaluation of Text System (REPETS) 620, and Risk Exposure Calculation System (RECS) 630. In some embodiments, request packets 602 may be processed by two or more of REEMS 610, REPETS 620, and RECS 630 so as to provide a multi-layer risk mitigation system.

As depicted in FIG. 6, requests 602 (e.g., TCP packets) are received, processed and forwarded to REEMS 610. In some embodiments, packets are received, processed and forwarded to REEMS 610 in real-time. As depicted, in some embodiments, the output from REEMS 610 may be transmitted to RECS 630 for a risk assessment. In some embodiments, REEMS 610 is configured to perform real-time risk scoring on data packets.

In some embodiments, REEMS 610 may be an automated system configured to process TCP packets 602. In some embodiments, REEMS 610 may track active TCP streams. In some embodiments, REEMS 610 may store packets that are part of the same TCP stream (i.e. connection) together. In some embodiments, REEMS 610 may store all of the packets that are part of the same TCP stream together. In some embodiments, each TCP stream may be mapped a user, the source of the network packet, and/or to a remote target URL domain (e.g., the destination node). In some embodiments, REEMS 610 may enrich the TCP stream data set with further data relevant for real-time processing.

In some embodiments, REEMS 610 is configured to determine an anomaly metric for each TCP stream. In some embodiments, the anomaly metric may be an anomaly score. In some embodiments, the anomaly score may be a decimal value between 0 and 1. The anomaly score may be indicative of how likely the active TCP stream is to be anomalous. An example embodiment of risk exposure and evaluation mitigation system 610 is described, for example, in U.S. Provisional Patent Application No. 63/714,479, filed Oct. 31, 2024, the entire contents of which are incorporated herein by reference.

In some embodiments, RECS 630 may determine risk levels associated with enriched TCP streams (e.g., TCP streams that have been enriched by REEMS 610 with metadata and other information about users, devices, remote target servers, and the like). In some embodiments, RECS 630 may calculate risk levels based on one or more different sets of ensemble ML models which have been trained for narrow, focused evaluations. In some embodiments, datasets used for different sets of ML models may be specifically constructed to achieve a narrow focus (e.g., for assessing governance and/or compliance). In some embodiments, ML models and ensembles of ML models may be dynamically and continually improved at run-time. In some embodiments, RECS 630 may add and/or remove ML ensembles at run-time, which is possible because ML ensembles may be executing in parallel at run-time. An example risk exposure calculation system 630 is described in U.S. Provisional Patent Application No. 63/714,488, filed Oct. 31, 2024, the entire contents of which are incorporated herein by reference.

In some embodiments, Risk Exposure Potential Evaluation of Text System (REPETS) 620 may be an automated system which downloads and extracts information from remote URL-domains and/or sets of remote URL-domains. As depicted, REPETS 620 may operate asynchronously from REEMS 610 and RECS 630. For example, request 602 data packets might not be processed in real-time by REPETS 620. Moreover, the output from REPETS 620 might not be required by RECS 630 to generate a real-time risk score.

In some embodiments, REPETS 620 may process documents in batches and may be configured to extract only relevant data to a particular configuration. In some embodiments, risk scores may be determined and used in order to determine the appropriate and/or necessary controls needed to be put in place to mitigate risks posed to organization 10 by request 602 (which may involve a user accessing a remote URL domain). REPETS 620 may be configured to continuously repeat. In some embodiments, REPETS may repeat on regular intervals. In some embodiments, REPETS may repeat on irregular intervals (for example, if a repetition is triggered by an event). An example Risk Exposure Potential Evaluation of Text System 620 is described in U.S. Provisional Patent Application No. 63/714,494, filed Oct. 31, 2024, the entire contents of which are incorporated herein by reference.

It will be appreciated that because each packet in a TCP stream may be evaluated as it is received, the anomaly score for a given TCP stream may change over time. As a result, in some embodiments, the risk score for a stream determined by REEMS 610 may vary over time, and the recommended action 604 returned by system 500 may also vary over time. Advantageously, some embodiments of system 500 may detect, in real-time, if a low anomaly score has changed to a high anomaly score. For example, if the anomaly score was previously below a threshold score, and has drifted to an anomaly score above the threshold, system 500 may react to this change and change the return action 604.

In some embodiments, a high anomaly score does not necessarily imply that a malicious actor and/or actions are present. For example, a TCP stream which consists of legitimate network traffic data packets may still be anomalous. In some embodiments, risk mitigation system 500 may be configured to discern between an anomalous TCP stream and malicious activity, which may be provide additional benefits over conventional systems in some circumstances.

For example, some embodiments described herein may detect network traffic patterns and user behaviour in the context of governance and compliance requirements, rather than without context. Such requirements may be specific to individual organizations 10, and as such, might not be possible to be taken into consideration by conventional network security software, which focuses only on intrusions and malicious activity and actors. Thus, conventional network security software is not suitable for evaluating user behaviour in the context of governance and compliance requirements, and is not sufficiently flexible to be configured to address context-specific requirements, such as governance and compliance requirements.

In the context of governance and compliance, users may be required to be distinguished based on many different attributes (or features) which include, but are not limited to: demographics, role, title, geographic location, computing device, and the like. Additionally, each organization may have its own set of internal policies and compliance requirements (which may deviate from typical regulatory and industry standards). Some embodiments described herein may allow system administrators to define such characteristics (i.e. attributes) and configure systems to detect specific patterns, and/or recommend specific actions. Moreover, some embodiments may allow system administrators to control and fine tune the sensitivity of the overall system due to the layered architecture and highly configurable capabilities of system 500, which may optimize action determinations in response to detected activities.

In addition to continuously detecting patterns, updating anomaly scores, and calculating and evaluating real-time risk, some embodiments of system 500 may provide externally exposed application programming interfaces (APIs). As depicted in FIG. 6, some embodiments may include administration/configuration API 640, and/or real-time API 642.

In some embodiments, real-time API 642 may provide functionality for adjusting the risk and action 604 determination of system 500 based on data from user devices 590 which are external to organization 10's private network. For example, system 500 may receive data from user devices which are part of SaaS providers and third party applications. In this case, users within organization 10 (e.g., employees) may be accessing SaaS and third party applications using organization 10's accounts, credentials, and/or authentication mechanisms.

In some embodiments, organization 10 may request, from SaaS and third party application providers, real-time usage data to be transmitted to system 500 via API 642. In some embodiments, the organization 10 may request a recommendation from system 500 for an action 604 to be taken, and/or to act on the action 604 recommended by system 500. In some embodiments, organization 10 may require the SaaS to request, administer and/or enforce the action 604 for SaaS users belonging to organization 10's account.

In some embodiments, externally-generated data may be added to one or more of real-time user-domain-action storage 644, and/or historical user-domain-action storage 646. The externally generated data may be used along with internal data for real-time decision making and/or continuous improvement processes (e.g., the training of machine learning (ML) models used by system 500).

In some embodiments, externally generated data may contain user and system identifiers, which may mapped by system 500 to internal data. For example, external data may be mapped to Server Name Indication (SNI) or Uniform Resource Locator (URL) domains.

Some example values of SNI identifiers may include “api.apple-cloudkit.com”, “firefox-settings-attachments.cdn.mozilla.net”, “res-1.cdn.office.net”, “incoming.telemetry.mozilla.org”, “static2.sharepointonline.com”, and “login.microsoftonline.com”. As may be apparent, some identifiers are differently worded yet should be grouped together (e.g. firefox-settings-attachments.cdn.mozilla.net and incoming.telemetry.mozilla.org”), whereas other identifiers might appear to belong in the same group but are not related to the same application (e.g., a Microsoft SNI for the Edge web browser likely should not be grouped together with a Microsoft SNI for the OneDrive cloud service, even if the text strings appear similar).

Thus, it is important to be able to correctly identify and distinguish between TCP streams, and to have ML models which are specifically tuned to detect anomalies in very narrow contexts (such as governance and compliance), calculate customized risk scores, and apply specific evaluations to determine actions 604 necessary for a specific context (such as the governance and compliance context). The governance and compliance context is particularly dynamic, and the configuration and flexibility, as well as continuous learning and improvement offered by embodiments described herein is necessary yet not available in conventional systems.

In some embodiments, a large proportion of TCP packets (requests 602) are expected to pass through system 500 with little to no interaction, given that most of the packets would not trigger processing if falling within the configurable acceptable anomaly score ranges. For example, TLS handshake packets with the “ClientHello” message will have an SNI value, and would require a URL-domain lookup and other processing. Of these packets, relatively few packets would be expected to represent new URL-domains that would trigger additional processing. The remainder of the TCP connection stream packets would be expected not to trigger any extensive processing. This is one of the reasons for system 500 making use of a layered approach with small, efficient, narrowly focused, fine-tuned ML models. Such fine-tuned ML models may be faster and less computationally expensive to continuously train, may run faster, may be capable of running in parallel, and can be used conditionally. As noted above, in some embodiments, REPETS 620 may be running asynchronously (i.e., not in real-time), and may continuously update the URL-domain data to prepare the URL-domain data for real-time processing.

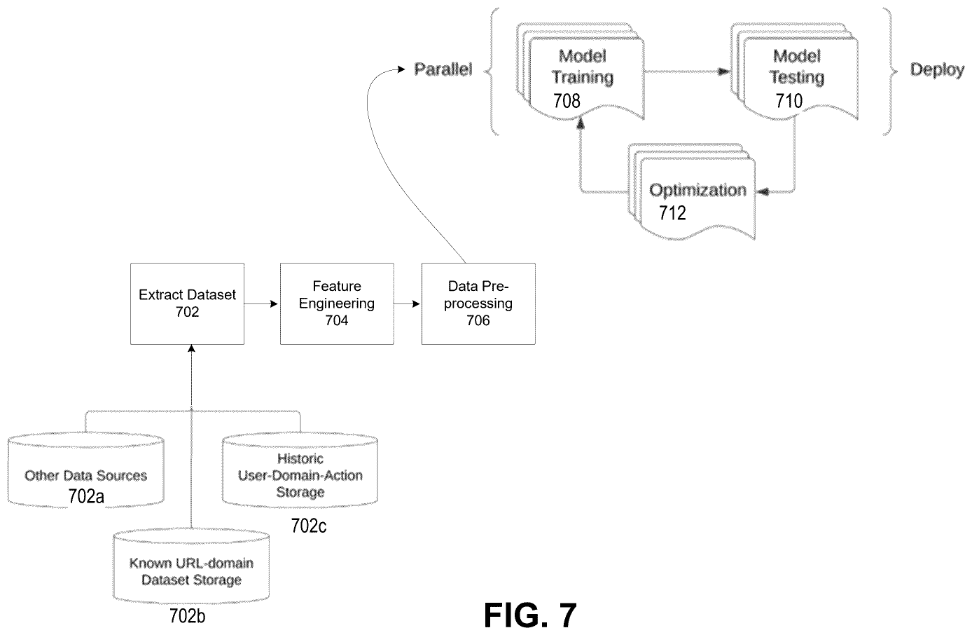

FIG. 7 depicts a simplified continuous machine learning model and improvement workflow, in accordance with some embodiments. As depicted, a dataset 702 is extracted from a plurality of data sources, including one or more of historic-user-action storage 702c, known URL-domain dataset storage 702b, and other data sources 702a. In some embodiments, other data sources 702a may include employee databases, incident databases, registries of risk/compliance data collected about third party service providers, and the like. At feature engineering block 704, features may be extracted from the extracted dataset. Some example features may include frequency of requests, the number of requests per day, the number of requests per hour, the time of day for a request, and the like. This feature data may then be pre-processed (e.g., normalized and/or scaled) at block 706, and then multiple ML models may be trained at block 708. In some embodiments, ML models may be trained in parallel. In some embodiments, trained models may be tested at block 710 and subjected to a validation feedback loop at block 712 until a desired level of accuracy is attained. In some embodiments, trained models may be continually updated and subjected to feedback loops as new data is received for recent time periods.

Returning to FIG. 6, in some embodiments, the output of REEMS 610 may be transmitted to RECS 630, which may calculate a real-time risk score (which is distinct from the above-noted anomaly score). In some embodiments, the determined real-time risk score may be processed at block 650 to determine what mitigation actions should be applied (if any).

In some embodiments, mitigation actions may include controls which may include, but are not limited to, actions such as “stop and hide” (in other words, a generic failure message which does not provide the real reason for stopping), “stop and warn” (i.e., raising a custom/specific error message), “proceed and warn” (i.e., do not halt execution, but provide a warning to the user), “proceed conditionally” (i.e., provide the user with an action to perform before allowing them to proceed), “proceed and log” (i.e., log the attempt, but do not stop the stream), and “proceed” (i.e., continue execution with no action).

In some embodiments, configurations may be made in a way to facilitate collaboration and integration of domain expertise from different corporate teams. In some embodiments, system 500 may allow for detailed data collection, analytics and reporting which can be customized to meet specific regulatory requirements related to Artificial Intelligence, SaaS, third party data sharing, and/or user privacy.

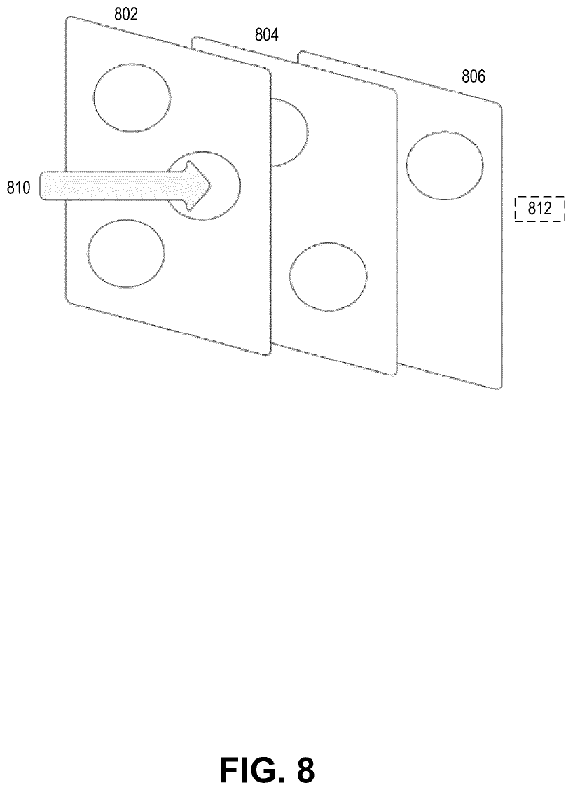

FIG. 8 is a conceptual depiction of a dynamic security control system using two-dimensional layers, in accordance with some embodiments. The depiction in FIG. 8 may be analogized to the “Swiss cheese” conceptual model commonly used in risk analysis and risk management. As depicted, each ‘slice’ 802, 804, 806 has randomly located holes of varying sizes. Each slice is arranged side-by-side. In this analogy, each slice represents a layer of system 500, and each hole represents flaws and security vulnerabilities. As depicted, a threat 810 may penetrate the first layer of the model. However, as the number of layers of security are increased, the likelihood of a threat penetrating the system decreases, as the only way for this to happen is if the holes are aligned across every one of layers 802, 804, 806, which becomes increasingly unlikely as the number of layers increase. In some embodiments, the right-most side of the model 812 beyond layer 806 may be viewed conceptually as non-compliance with one or more governance or compliance policies within an organization.

Continuing with this analogy, some embodiments of the invention are dynamic, in the sense that the size and location of the holes in each layer may vary over time (as received TCP packet requests 602 are continuously received and evaluated, and additionally due to the ML models are continuously asynchronously re-trained). As such, it becomes increasingly unlikely that a threat 810 may be able to penetrate the dynamic, constantly moving and re-shaping holes in each layer 802, 804, 806. Moreover, in some embodiments, the number of layers of processing 802, 804, 806 may increase or decrease depending on the risk level assessed by system 500. For example, network packets determined to represent a very low risk may be subject to fewer or less strict controls (i.e. removing some layers, to improve efficiency), whereas network packets determined to represent higher risks may be subject to more, or more stringent controls (i.e. adding layers to ensure sufficient layers are applied).

The Open Systems Interconnection (OSI) standard model includes the following networking layers: a) Layer 1: Physical Layer—the physical connection between devices (raw bit streams over a physical medium); b) Layer 2: Data Link Layer—node-to-node data transfer and error correction from the physical layer; c) Layer 3: Network Layer—routing of data packets across different networks (e.g., Internet Protocol (IP)); d) Layer 4: Transport Layer—Reliable data transfer services to the upper layers (e.g., Transmission Control Protocol (TCP) ensuring data is delivered error-free, in sequence, and with no losses or duplications); e) Layer 5: Session Layer—Manages sessions or connections between applications (e.g., NetBIOS, RPC, PPTP); f) Layer 6: Presentation Layer—Translates data between the application layer and the network format, handling data encryption, compression, and translation (e.g., SSL/TLS, MIME, XDR, JPEG, GIF, ASCII); and g) Layer 7: Application Layer—Provides network services directly to end-user applications.

Some embodiments described herein may operate at Layer 7 of the OSI model (i.e., the application layer), and may filter incoming requests using various protocols described herein. Some common Layer 7 protocols include:
HTTP/HTTPS (Hypertext Transfer Protocol/Hypertext Transfer Protocol Secure): Used for the internet data transfer, HTTPS is using SSL/TLS for encryption.
FTP (File Transfer Protocol): Used for transferring files.
SMTP (Simple Mail Transfer Protocol): Used for sending emails.
IMAP (Internet Message Access Protocol)/POP3 (Post Office Protocol 3): Used for retrieving emails from a server.
DNS (Domain Name System): Translates domain names into IP addresses.
Telnet: Used for remote command-line access.
SSH (Secure Shell): Secure protocol for remote command-line access and other secure network services.
SNMP (Simple Network Management Protocol): Used for network management and monitoring.
LDAP (Lightweight Directory Access Protocol): Used for accessing and maintaining distributed directory information services.
SIP (Session Initiation Protocol): Used for initiating, maintaining, and terminating real-time sessions (voice, video, and messaging).
RDP (Remote Desktop Protocol): Used for remote access to desktops and applications.
NFS (Network File System): Used for distributed file systems.
SMB (Server Message Block): Used for Providing Shared Access to Files, printers, and serial ports.

Although some embodiments described herein relate specifically to the use of HTTP/HTTPS protocols, it is contemplated that similar principles and techniques may apply and be used with other protocols.

Some embodiments described herein relate to training multiple ML models, as depicted in the example workflow of FIG. 7. In some embodiments, an example workflow for collecting and training ML models may include:
1) Data Collection: Network traffic may be captured in real-time, and stored historical data may be retrieved as well. Common tools may include Wireshark or tcpdump. However, in a large organization, many applications may be dedicated to the capture and analysis of network traffic, both by capturing real-time network traffic and keeping historical data. Other data sources, such as employee records, IP address registries, etc. may also be available and may be useful in linking and/or and correlating data. This may create a large set of related datasets 702a, 702b, 702c from which to extract data. In some embodiments, the pool of these datasets is generalized, and might not be specifically created for ML training and testing consumption, or any other specialized consumption use case.
2) Feature Extraction 704: a process of extracting relevant attributes from the datasets created in the Data Collection block 702. Datasets specifically tailored for training and testing of specific ML models may be created.
3) Data Pre-processing 706: Once the datasets are created for specific ML models, the data may be cleaned. Some examples of cleaning may include by removing missing values, defaulting, standardizing values and formats, and the like. Depending on the ML model being trained, data may have to be scaled, normalized, or conditioned in other ways. Tools and libraries for such conditioning operations may be publicly available.
4) Clustering: In some embodiments, unsupervised classification of network traffic may be performed, which may include creating clusters. Clustering may have a significant impact on some embodiments described herein.
5) Model Evaluation: takes the results of the Clustering block and interprets the results. For example, in the case of clustering, the results should be interpreted to be used when embodiments are deployed.
6) Deployment: ML models, which have been trained to classify real-time network traffic, may be deployed, as described below. Some embodiments may be configured to continuously monitor and update the ML model(s) (e.g., the feedback loop depicted at blocks 708, 710, 712) to adapt to new types and/or patterns of traffic.

As noted above, some embodiments described herein make use of machine learning (ML) techniques to process network traffic. In some embodiments, ML techniques used for network traffic processing may be subdivided into supervised learning, unsupervised learning, and deep learning techniques.

Supervised Learning may include, for example, classification algorithms and/or feature engineering. Classification Algorithms may include Decision Trees, Random Forests, Support Vector Machines (SVM), and Neural Networks, which can all be trained using labeled datasets to classify network traffic.

Feature Engineering 704 may include, for example, extracting relevant features from the traffic data, such as packet size, duration, and frequency. In some embodiments, feature extraction may be crucial for effective classification performance by ML classifiers.

Unsupervised Learning may include, for example, clustering algorithms and anomaly detection. Clustering Algorithms may include algorithms such as K-Means, Density-Based Spatial Clustering of Applications with Noise (DBSCAN), and Hierarchical Clustering, which can group similar types of traffic together without prior labeling.

Anomaly Detection may include, for example, techniques such as isolation forests and autoencoders, which can identify unusual traffic patterns (which may be indicative of security threats, in some embodiments).

Deep Learning may include, for example, convolutional neural networks (CNNs) and Recurrent Neural Networks (RNNs). In some embodiments, CNNs can be used for traffic classification by treating traffic data as images or sequences. In some embodiments, RNNs may be useful for analyzing sequential, time-series data and identifying patterns over time.

Some common use cases for ML techniques may include, for example, 1) Intrusion Detection Systems (IDS) which detect anomalies and potential security threats; 2) traffic analysis and monitoring, which may identify different types of application traffic (e.g., HTTP, FTP and DNS), and can be used for network management and monitoring; 3) Quality of Service (QoS), which may be used to classify traffic into higher and lower priority traffic to ensure more critical packets are given priority; 4) content filtering, which can be used to identify and block unwanted or harmful content based on traffic analysis; and 5) network optimization, which can be used to improve efficiency of allocation of network resources.

In modern browser-based applications, the majority of network traffic will typically be secured and/or encrypted using the Hypertext Transfer Protocol Secure (HTTPS), through Secure Sockets Layer (SSL)/Transport Layer Security (TLS). The network traffic may be split into network data packets, and may require assembly into separate streams. In some embodiments, the tcp. stream field may be used to identify network data packets belonging to the same TCP stream.

In some embodiments, capturing metadata for HTTPS traffic may provide insights without the need for decryption of the payload. In some embodiments, metadata may include one or more of the source IP address, the destination IP address and port, as well as packet size. Packet size may vary due to several factors, such as the size of the payload, encryption and protocol overhead, and fragmentation. For example, each packet may have a maximum transmission unit (MTU) size, which is typically around 1500 bytes for Ethernet data packets.

In addition to the above-noted Source and Destination IP addresses, in some embodiments, metadata may further include one or more of the Source port number, the Destination port number, the Length of the payload (since the payload is encrypted), Timestamp (the time at which the packet was captured), Protocol (the protocol used (e.g., TCP, UDP)), Flags (TCP flags (e.g., SYN, ACK, FIN)), Sequence Number (the sequence number of the TCP packet), Acknowledgement Number (the acknowledgement number of the TCP packet tells the sender that all bytes up to, but not including, the acknowledgement number have been received successfully), Window Size (the TCP window size used for flow control and adjusted window_size_scalefactor as a power of 2), SSL Handshake Type (available only during TLS handshake, Server Name Indication (SNI) (available only during TLS handshake), and/or Common domain name (e.g., rbc.com, google.com, or the like).

During the initial TLS handshake between a client and a server, a Server Name Indication (SNI) value may be available. The SNI value is the domain name of the server (such as rbc.com, meteo.gc.ca, or the like). Some embodiments described herein may use the SNI field to look up whether the domain (URL) is known to the risk exposure evaluation and mitigation subsystem 610 or not, which is described in greater detail below.

Once the TLS handshake is complete, the source and destination IP addresses, as well as the source and destination ports, will remain constant for the duration of the now-established TCP connection. The IP addresses and ports are established during the initial TCP handshake, and are used consistently throughout the connection, which some embodiments described herein may take advantage of to create an enriched real-time packet dataset. In some embodiments, the enriched dataset may contain relevant data not only from the current network data packet, but also relevant attributes collected from previous packets, as well as attributes collected from other systems (including, but not limited to, demographic and employment data collected using the source IP address). Further embodiments described herein may also use this data for downstream processing.

Some embodiments may leverage SSL/TLS handshakes. Some examples of SSL/TLS handshake types may include:
(1) ClientHello: This message is sent by the client to initiate a TLS handshake. It includes the client's supported cipher suites, TLS version, and other parameters.
(2) ServerHello: This message is sent by the server in response to the ClientHello. It includes the server's chosen cipher suite, TLS version, and other parameters.
(11) Certificate: This message is sent by the server (and optionally by the client) to provide the certificate chain to the peer.
(12) ServerKeyExchange: This message is sent by the server when the server's certificate does not contain enough information to complete the key exchange.
(13) CertificateRequest: This message is sent by the server to request a certificate from the client.
(14) ServerHelloDone: This message is sent by the server to indicate that the ServerHello and associated messages are complete.
(15) CertificateVerify: This message is sent by the client to provide proof that it possesses the private key corresponding to the client certificate.
(16) ClientKeyExchange: This message is sent by the client to provide the key material for the key exchange.
(20) Finished: This message is sent by both the client and the server to indicate that the handshake is complete and that future messages will be encrypted.

The following is an example set of TCP packet metadata during the Client Hello (type 1) TLS handshake.
“tcp_id”: “23”,
“ts”: “2024-10-03 15:47:12.186109”,
“prot”: “TCP”,
“p_sz”: “583”,
“w_sz”: 58028439341502200385896448,
“tcp_fl”: “0x0018”,
“seq_num”: “132”,
“ack_num”: “40”,
“src_ip”: “10.94.77.75”,
“dst_ip”: “10.237.20.194”,
“src_pt”: “54796”,
“dst_pt”: “8080”,
“ttl”: “64”,
“ssl_type”: “tls”,
“tls_hs”: “1”,
“tls_hs_str”: “ClientHello”,
“sni”: “api.apple-cloudkit.com”,

In the above-noted example, the SNI value is api.apple-cloudkit.com, which can be leveraged or otherwise used by some embodiments described herein. In some embodiments, the values of SNI may be hashed. Some non-standard implementations may have other non-URL-domain strings, or may omit them. In such situations, some embodiments described herein are configured to analyze the ClientHello packets and extract SNI information using fine-tuned ML models trained at least in part on historical data and continuously improved through the training process depicted in FIG. 7.

Other examples of SNI values are “firefox-settings-attachments.cdn.mozilla.net”, “incoming.telemetry.mozilla.org”, and “login.microsoftonline.com”. These examples illustrate why it is important to correctly identify TCP streams (connections) and to have ML models specifically tuned to detected anomalies (particularly in the context of governance and compliance), calculate customized risk scores, and apply specific evaluations to determine actions 604 necessary for a governance and compliance context. The governance and compliance domain and context is dynamic, and the configuration and flexibility as well as continuous learning and improvement offered by some embodiments described herein may be particularly advantageous relative to current systems, which do not offer such configurability and flexibility.

The following are common TCP flags which may be used in some embodiments described herein:
SYN (Synchronize): Initiates a connection.
ACK (Acknowledgement): Acknowledges the receipt of a packet.
FIN (Finish): Indicates the end of data transmission.
RST (Reset): Resets the connection.
PSH (Push): Pushes the buffered data to the receiving application.
URG (Urgent): Indicates that the data should be processed immediately.
ECE (ECN-Echo): Indicates congestion in the network (used for Explicit Congestion Notification).
CWR (Congestion Window Reduced): Indicates that the sender has reduced its sending rate (used for Explicit Congestion Notification).
NS (Nonce Sum): Used to protect against accidental malicious concealment of packets (experimental).

During a typical TCP connection life-cycle, TCP flags typically follow a well-known, established pattern. For example, the most common pattern is the following three stages:

### 1. Connection Establishment (Three-Way Handshake)

SYN: The client sends a SYN (synchronize) packet to the server to initiate a connection.
SYN-ACK: The server responds with a SYN-ACK (synchronize-acknowledge) packet to acknowledge the receipt of the SYN packet and to synchronize its own sequence number.
ACK: The client sends an ACK (acknowledge) packet to acknowledge the receipt of the SYN-ACK packet. The connection is now established.

### 2. Data Transfer

PSH: The PSH (push) flag is used to push data to the receiving application immediately.
ACK: The ACK flag is used to acknowledge the receipt of data packets. This flag is set in most packets after the connection is established.

### 3. Connection Termination (Four-Way Handshake)

FIN: The client or server sends a FIN (finish) packet to initiate the termination of the connection.
ACK: The receiving end acknowledges the receipt of the FIN packet with an ACK packet.
FIN: The receiving end then sends its own FIN packet to terminate the connection from its side.
ACK: The original sender of the FIN packet acknowledges the receipt of the second FIN packet with an ACK packet. The connection is now terminated.

Using this example, some embodiments described herein may be configured to recognize these patterns as:
SYN, SYN-ACK, ACK: Used for connection establishment.
PSH, ACK: Used for data transfer.
FIN, ACK: Used for connection termination.

Additional typical, expected patterns may include:

### 1) Retransmissions:

Duplicate ACKs: If a packet is lost, the receiver may send duplicate ACKs for the last successfully received packet. This transmission of duplicate ACKs prompts the sender to retransmit the lost packet.
Retransmitted Packets: The sender may retransmit packets if it does not receive an acknowledgment within a certain time frame.

### 2) Out-of-Order Packets:

Packets may arrive out of order due to network routing. The receiver will buffer these packets and reorder them based on sequence numbers.

### 3) Window Size Adjustments:

The TCP window size may be adjusted dynamically based on network conditions and the receiver's buffer capacity.

### 4) Keep-Alive Packets:

TCP keep-alive packets are sent periodically to maintain an idle connection. These packets typically have no payload and are acknowledged by the receiver.

### 5) RST (Reset) Packets:

An RST packet is sent to immediately terminate a connection. This can happen if a packet is received for a closed connection or if there is an error.

Some anti-patterns or anomalies may be detectable by some embodiments. Some example anomalies may include:

### 1) Unusual Flags:

SYN Flooding: A large number of SYN packets without corresponding SYN-ACK and ACK packets can indicate a SYN flood attack.
FIN Flooding: A large number of FIN packets without proper connection establishment can indicate a FIN flood attack.
RST Flooding: A large number of RST packets can indicate an RST flood attack.

### 2) Sequence Number Anomalies:

Out-of-Range Sequence Numbers: Sequence numbers that do not match the expected range can indicate packet injection or corruption.
Duplicate Sequence Numbers: Repeated sequence numbers without retransmission context can indicate anomalies.

### 3) ACK Anomalies:

ACK Storms: A large number of ACK packets without corresponding data packets can indicate an ACK storm, often caused by network loops or misconfigurations.

### 4) Unusual Packet Sizes:

Very Large or Very Small Packets: Packets with sizes that deviate significantly from the normal size can indicate issues such as fragmentation attacks or misconfigurations.

### 5) Timing Anomalies:

High Latency: Unusually high latency between packets can indicate network congestion or routing issues.
Jitter: High variability in packet arrival times can indicate network instability.

### 6) Connection Duration:

Very Short or Very Long Connections: Connections that are terminated almost immediately or that remain open for an unusually long time can indicate anomalies.

Some embodiments may be configured to recognize these anomalies, and such anomalies may later be used during an evaluation phase. An important aspect is that some embodiments are capable of successfully classifying all HTTPS traffic without the need for decryption. Another important aspect is that some embodiments are configured to keep track of the destination domains for each user identified by the organization 10, which may enable creation of ML models at various levels of granularity (including, but not limited to, the employee, the team, the job/role class/category, geographic location, and the like) and aggregations thereof.

With the increasing prevalence of Work-From-Home (WFH) and hybrid work arrangements, some embodiments may detect WFH patterns and compare them to in-office patterns at different aggregation levels. In some aspects, this can be used for governance and compliance, among other possible use cases.

When traffic is routed through a proxy server, which is a typical corporate situation, the source and destination IP addresses in the network data packets must be correctly identified, which depends on the type of proxy and how it is configured. The following are some of the most common configurations:

### 1) Forward Proxy:

Source IP Address: The source IP address will be that of the proxy server.
Destination IP Address: The destination IP address will be that of the target server (e.g., a web server).

### 2) Reverse Proxy:

Source IP Address: The source IP address will be that of the client machine.
Destination IP Address: The destination IP address will be that of the proxy server.

### 3) Transparent Proxy:

Source IP Address: The source IP address will be that of the client machine.
Destination IP Address: The destination IP address will be that of the target server, but the proxy intercepts the traffic.

When a client is trying to establish an HTTPS connection with a remote target server, the client will first send an HTTP CONNECT request to the proxy server to establish a tunnel.
Packet 1: SYN Client->Proxy HTTP CONNECT.
Source IP: Client's IP address
Destination IP: Proxy server's IP address
Source Port: Client's source port
Destination Port: Proxy server's port (usually 8080 or 3128)
HTTP Method: CONNECT
HTTP Headers: could be a part of the encrypted payload if proxy connection is encrypted, however, this is an internal encryption that an organization has access to. Example HTTP headers may include:
a) Host: Target server's hostname would be equivalent to the SNI in non-proxy or transparent proxy communication.
b) Proxy-Connection: keep-alive
c) Proxy-Authorization: typically required in large organizations, the proxy-authorization header will have credentials for proxy authentication, and would typically identify the user, an employee of this organization or a guest user.

In some embodiments, it is possible to bind the source IP address and client IP address to the employee using it, and to the device fingerprint which may be calculated based on HTTP headers, or may already have been created using various tools and libraries which would be standard practice at large organizations. This data could be made available in some embodiments, depending on the type of integration with other layers of the multi-layered risk mitigation system 500.

Once the Proxy authenticates the client and receives a CONNECT message, the proxy server may establish its own connection to the remote target server on behalf of the client. This is a separate TCP connection between the Proxy server and the target server. Thus, the proxy server sends SYN to the target, the target responds with SYN-ACK, and the proxy server will respond with an ACK, at which point the connection with the remote target server is established. At this point, the proxy maps the two separate TCP connections.

After the initial request from the client (SYN packet), and after the proxy server has established its own TCP connection, the proxy server may respond to the CONNECT request to indicate that the connection has been established with an HTTP 200 Connection Established response, SYN-ACK. The client will respond with an ACK to confirm the TCP connection. At this point, a TCP connection is established between the client and the proxy with a distinct and unique packet. tcp. stream field value. The value of the TCP stream will not change for the duration of this TCP connection. Each connection from the client to a distinct remote target server via proxy will have a separate, different and unique TCP connection with its own stream field value. Most proxies transparently forward payload segments, and only manipulate the TCP metadata in order to map the traffic between two separate TCP connections. Some embodiments described herein may leverage this fact to enable integration of a multi-layer risk mitigation system 500 into many different environments and systems.

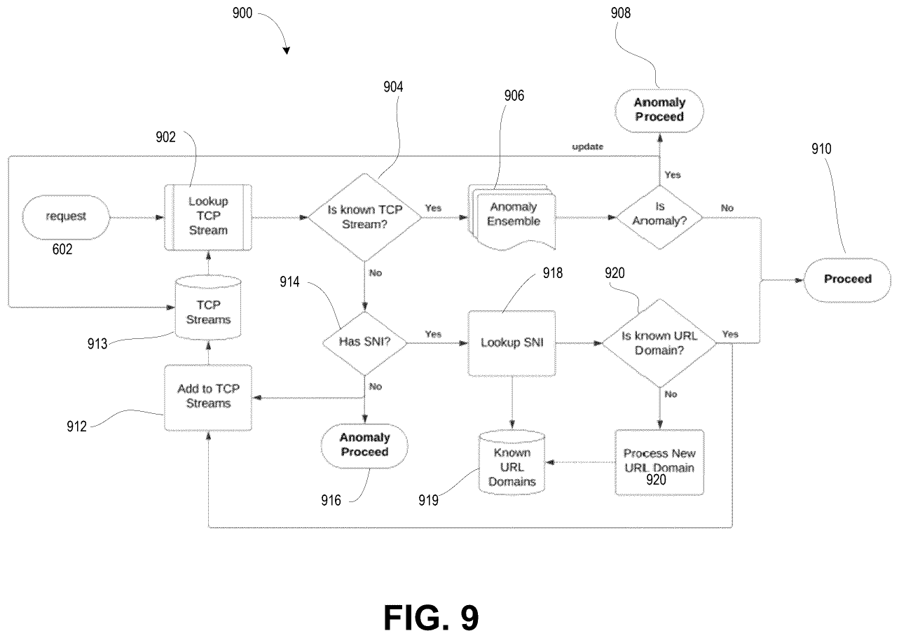

FIG. 9 depicts a workflow 900 for processing of an outgoing (egress) network packet (referred to as request 602, consistent with the previous figures). As described above, at block 902, the TCP stream may be extracted and a lookup is made to at block 904 to determine if the TCP stream is a part of an active stream 913. If request 602 is a part of an active TCP connection (e.g., a stream of packets), an ensemble of anomaly detection ML models 906 is executed and an anomaly flag is added to the request dataset at block 908. After the anomaly flag has been added, the processing is allowed to proceed to blocks 908 or 910, as the case may be. The active TCP stream may also be updated at block 912 so that when the next request 602 in the stream is received, the anomaly detection will run again.

In some embodiments, if request 602 is a new request (e.g., if the TCP stream is not found in the set of active streams 912), block 904 will determine that the TCP stream is not a known stream and proceed to block 914. At block 914, the packet may be checked for the presence of TLS handshake and SNI. If no TLS handshake or SNI are found, then the request 602 may be flagged as an anomaly at block 916, and stored, before the processing proceeds. Some embodiments described herein might not function as a final decision-making security system, and might only detect and report anomalies for processing by other system components.

In some embodiments, request packets 602 may be received out-of-order. In this case, the next requests 602 may update the TCP stream, and the anomaly flag may be removed. At block 914, if an SNI is detected, a lookup is made at block 918 to determine whether this domain is already known to the system (e.g., already contained in the known URL domain dataset 919). At block 920, if the domain is already known, the processing will proceed to block 910 and the TCP active stream storage 912 will be updated. At block 920, if the domain is not already known to the system, the TCP active stream may be updated, and an event may be raised so that REPETS 620 will process the new domain at block 922. In some embodiments, REPETS 620 may process the new domain asynchronously (i.e., out-of-process and not in real-time).

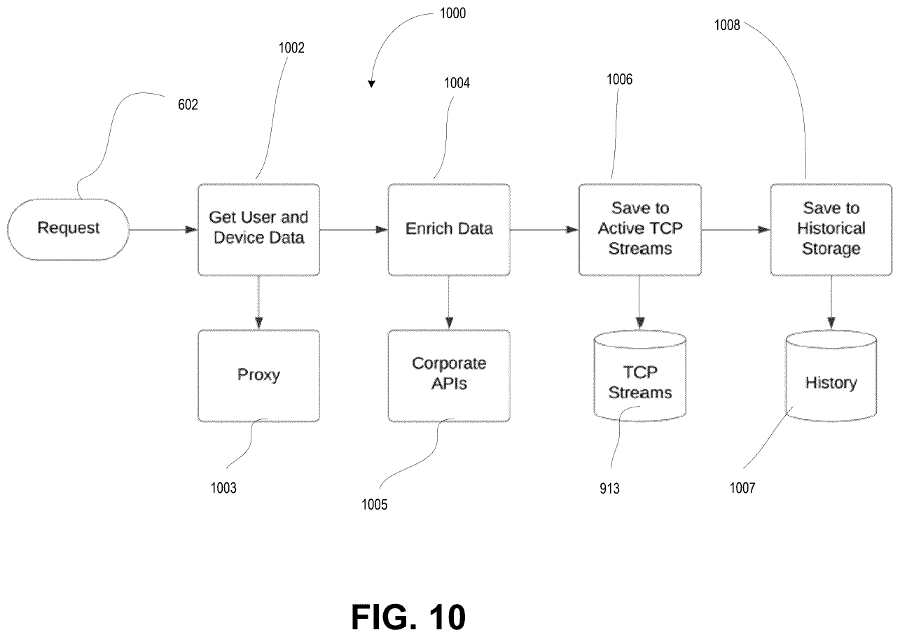

FIG. 10 depicts an example data gathering, processing, and persisting workflow 1000, in accordance with some embodiments. As depicted, a device (e.g. a client device) is used by a user (e.g., an employee) to make a request 602 to a target server which is external to private network 10 through a user agent (e.g., a user agent may be a browser). As depicted, at block 1002, user agent (e.g., web browser) and device attributes may be collected. In some embodiments, collected user agent and device attributes are referred to herein as a ‘device fingerprint’. In some embodiments, a device fingerprint may be created or calculated using a hashing function.

In some embodiments, risk exposure evaluation and mitigation subsystem 610 may be integrated behind a corporate proxy server 1003, as noted above. Since the users (e.g., employees) must be authenticated by the proxy server 1003, some embodiments may be configured to obtain user and device information, either from the proxy server 1003, or from specialized APIs 1005 and/or data stores optimized for providing user and device information. Once the user and device are identified, the request dataset is enriched at block 1004 with other attributes as indicated above to enhance real-time processing and historical records 1007 that will be used to train ML models.

Returning to FIG. 7, which illustrates an example workflow for continuously improving ML models deployed as an ensemble for anomaly detection. As depicted, these ML models 708 may rely on historical data 702c to learn characteristics and features of anomalous network data packet flows. Each model 708 may be trained on a dataset created in a specific context (e.g., historic user domain, user-job-domain, user-team-domain, organization-domain, standard-network-flow, or the like). When these ML models run in an ensemble, the ensemble configuration may be dynamically adjusted based on real-time context. For instance, if the user is accessing a domain for the first time, the weight of the user-domain may be reduced to 0 in the ensemble overall scoring calculation. In some embodiments, the overall score may be a decimal value between 0 and 1, which indicates if a stream is anomalous.

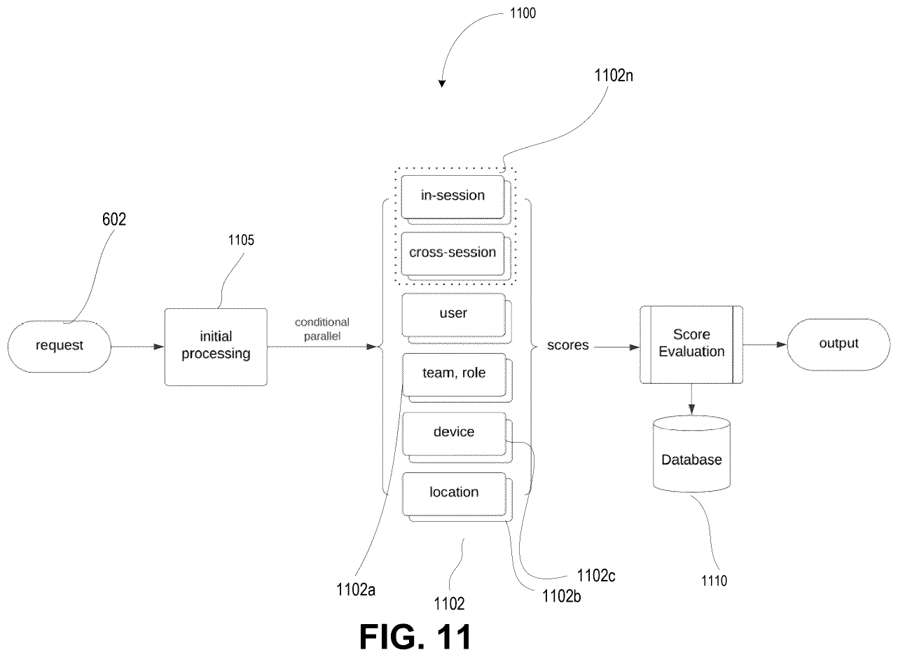

FIG. 11 is a high-level logical illustration of an example workflow 1100 for determining a risk score for network data packets. For example, a dataset comprising active TCP connections for the user, device, and remote target system may be processed by sets of Machine Learning (ML) ensembles trained for narrowly focused tasks based on datasets specifically constructed to have a narrow contextual focus. An example narrow contextual focus may include the context of governance and compliance. Some embodiments of this approach may be based on, for example, U.S. patent application Ser. No. 16/953,783, now granted as U.S. Pat. No. 12,058,135, filed Nov. 20, 2020, and entitled “System and Method for Unauthorized Activity Detection”, the entire contents of which are incorporated herein by reference.

As depicted in FIG. 11, after initial processing 1105 of a data packet/request 602 (e.g., by REEMS 610), parallel ML models 1102 may process the request 602 including the enriched metadata associated with request 602. In some embodiments, risk exposure calculation subsystem (RECS) 630 is configured to dynamically determine which of the multiple sets of ML models 1102a, 1102b, 1102c, . . . , 1102n should be run for each request 602. In some embodiments, the determination of which ML models to execute is based on the dataset and enriched metadata contained in request 602, and/or the system configuration.

In some embodiments, each set of ML models 1102a, 1102b, 1102c may be used as an ensemble. In some embodiments, the determination of which of the multiple sets of models 1102 will be executed is determined at the initial processing block 1105. Based on the output of the initial processing block 1105, some embodiments of RECS 630 may be configured to conditionally add and/or remove ML ensembles to the next parallel processing step. In some embodiments, the output of all parallel execution steps may be collected and stored in a database 1110.

In some embodiments, the database 1110 may store data which covers a time period. In some embodiments, the time period is a configurable rolling window of time. This time window may allow the system 630 a broader view of user and remote target server interactions, as well as all user interactions with all target servers, and target server interactions with all users.

In some embodiments, sets of ML ensembles 1102 based on unsupervised learning approaches may be used to generate risk scores for a request 602 based on the probability that a given dataset is an outlier. For example, the Isolation Forest technique may be used to identify outliers. The Isolation Forest technique functions by isolating points in the feature (e.g., attribute) space, and identifying anomalies as the points that require relatively fewer splits to isolate.

In some embodiments, outliers may be identified using the One-Class Support Vector Machines (SVMs) technique. The one-class SVM approach learns the boundary of the “normal” or “regular” data points and labels outliers outside of the boundary as anomalies.

In still other embodiments, autoencoders may be used to identify outliers. Autoencoders are Neural Networks configured to learn the patterns of the “normal” or “regular” data points and use reconstruction error (i.e., the delta between the input and output) as an anomaly score.

In still other embodiments, semi-supervised learning approaches may be used. Typically, semi-supervised learning approaches are used when data that can be labelled as “normal” or “regular” is available. Often, organizations 10 may have access to such data (e.g., datasets 1007, 702c, 702b, 702a, and the like), which may be labeled. In still other embodiments, Local Outlier Factor (LOF) techniques may identify outliers by measuring the local density of points, and flagging points with significantly lower density as the outliers.

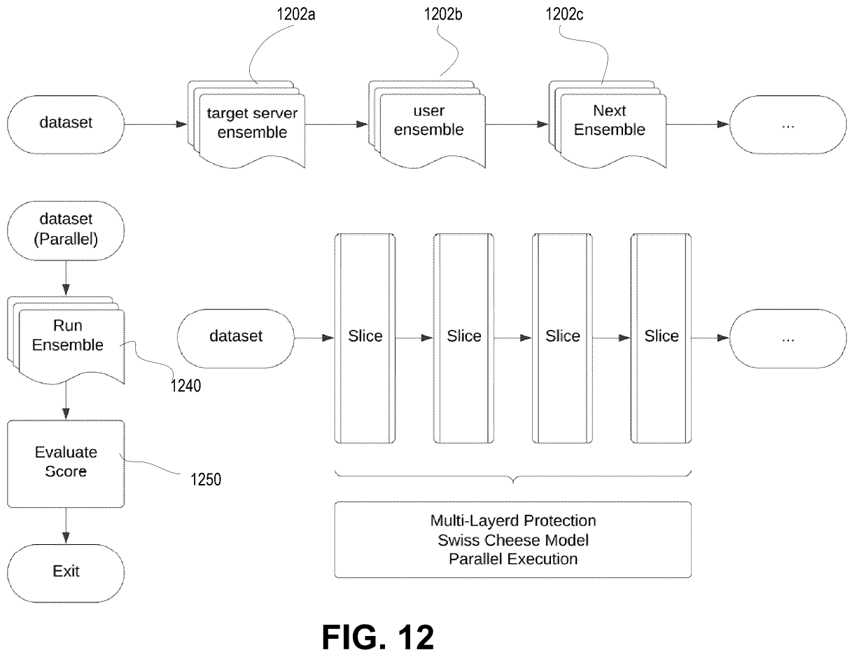

As depicted in FIG. 12, in some embodiments, at block 1240, the risk score 1250 for an ensemble may be determined by running a set of ensembles 1202a, 1202b, 1202c, . . . 1202n in parallel, with each ensemble having different tuning parameters. As noted in FIG. 12, the number of layers (e.g., the number of sets of ensembles from 1202a, 1202b, 1202c) may be varied depending on the particular circumstances. In situations which demand heightened protection, more layers can be applied to the dataset. In situations which have lower need for protection, one or more layers can be omitted from the process so as to improve processing efficiency.

In some embodiments, data sets used for training ML models 1102 may include historical data 1007, and/or subsets of recent data. For example, a subset of recent data might be a rolling time window including data from the past 24 hours. In this manner, historical data may be used to capture longer-term patterns, while recent data may be used to capture short-term trends.

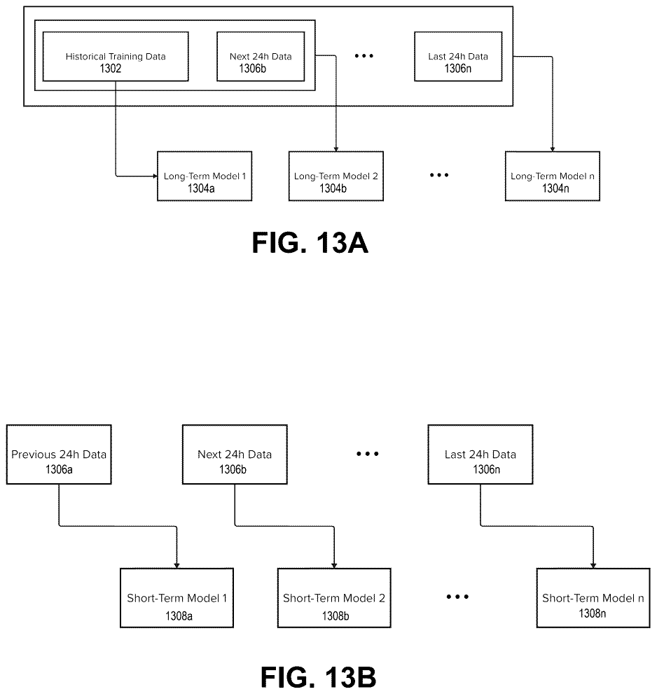

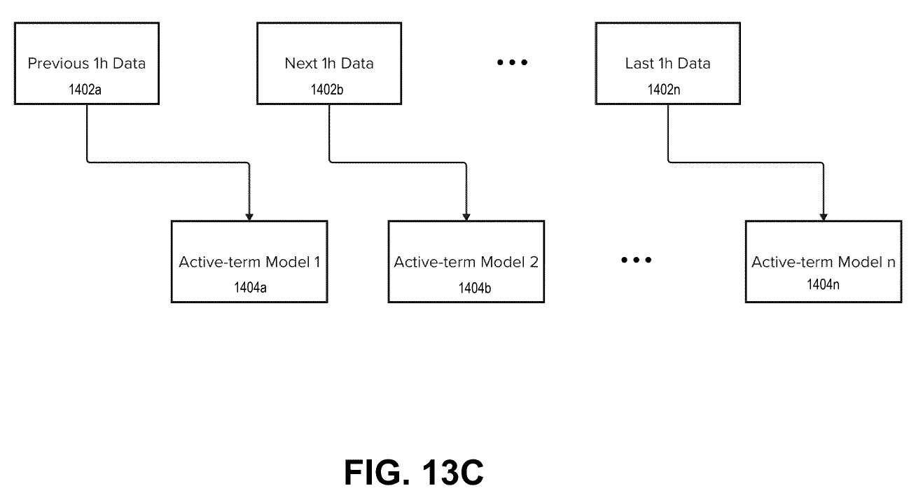

FIG. 13A depicts an ensemble of ML models trained using historical training data 1302 and/or a combination of historical training data and short-term trends. As depicted, long-term model 1 1304a may be trained using only historical training data 1302. Long-term model 2 1304b may be trained using historical training data 1302 combined with training data 1306a from a more recent 24 hour period. This extension through varying windows of time may be generalized to long-term model n 1304n, which is trained using a combination of historical data 1302, together with a plurality of 24 hour periods up to the last 24 hours 1306n.

Some embodiments may include the creation of ensembles with ML models trained on both long-term historical data 1302, and models trained on short-term trend data 1306a, 1306b, . . . 1306n. An example of a rolling window is depicted in FIG. 10B, in which short-term model n 1308n is trained using data 1306n from the most recent 24 hour period, and a plurality of other short term models (e.g. short term models 1308a, 1308b) in the ensemble are trained using other distinct earlier 24 hour periods 1306a, 1306b.

In some embodiments, a third set of ensembles may be trained for the currently active data (referred to herein as active-term data 1402). In some embodiments, the currently active data 1402 may represent active connections/session data, and/or “last-mile data” (e.g., data obtained in the past hour). FIG. 10C depicts an example workflow for training an ensemble of active-term ML models 1404. As depicted, active term model n 1404n may be trained based on the previous hour of data 1402n, whereas as a plurality of other active-term models (e.g. active-term model 1404b and 1404a) may be trained using 1 hour windows of data 1404b, 1404a which are further in the (relatively recent) past.

In some embodiments, the datasets for each of these time-frames may be adjusted as follows:
1) For long-term historical data 1302, the already-trained model 1304a may focus on data that slowly changes over longer periods of time (e.g., typical traffic rates, user behaviour (profiles, classification, etc.), typical choice of target servers, days and times of activity, and the like).
2) For short-term trends data 1306, the model 1308 may be continuously trained in near-real-time, and may focus on statistical data that is continuously aggregated over the short-term window duration (e.g., 24 hours, or whichever time period is being used for short-term data). Examples of such statistical data may include, for example, average packet size, frequency of connections, connection attempts, the number of simultaneous connections to all targets, to specific targets, number of target servers, variances in behaviour, and the like.
3) For active-term, last-mile data, the dataset may be similar to short-term trends data, without aggregating over the short term. For example, different active-term models 1404 may be generated using short term time periods 1402 (e.g. 1 hour windows) which do not overlap, as depicted in FIG. 10C. Examples of such data may include, for example, number of attempts, burst patterns, and rates.

In some embodiments, each set of ensembles may include one or more of the above-described long-term, short-term, and active-term anomaly detection ML models. In some embodiments, these sets of ensembles may form part of a super-ensemble, with an ensemble set for each of long-term data 1304, short-term trends data 1308, and active-term, last mile data 1404. In this super-ensemble, weights may be assigned for each data time period based on the importance of each. For example, the weights may be determined dynamically based on the current real-time dataset, from pre-set weight ranges defined by the system administrators in the system configuration.

In some embodiments, RECS 630 may execute several weight distributions in parallel. For example, there may be a default set of weights(e.g., set by configuration), and one or more variations of dynamically calculated and assigned weights. In some embodiments, one or more of the determined scores may be returned to risk evaluation and mitigation subsystem 500, where the final decision 604 is made on which mitigation action or set of actions will be proposed to the user.

Returning to FIG. 7, which depicts an example workflow for continuously training ML models based on historical data. In some embodiments, ML models may be trained in parallel. In some embodiments, trained models may be tested and subjected to a validation feedback loop until a desired level of accuracy is attained. In some embodiments, trained models may be continually updated and subjected to feedback loops as new data is received for recent time periods.

In some embodiments, the process of training ML models may be continuously or regularly repeated at a regular interval. In some embodiments, the interval may match the short-term trend window 1306 (e.g., between 24 and 48 hours). Of course, system administrators may select different time intervals as desired. In some embodiments, by using the same interval as the short-term trend window, the system may become optimized because the ML models trained in this manner may be used as a basis for fine-tuning of both short-term 1308 and active-term 1404 ML models.

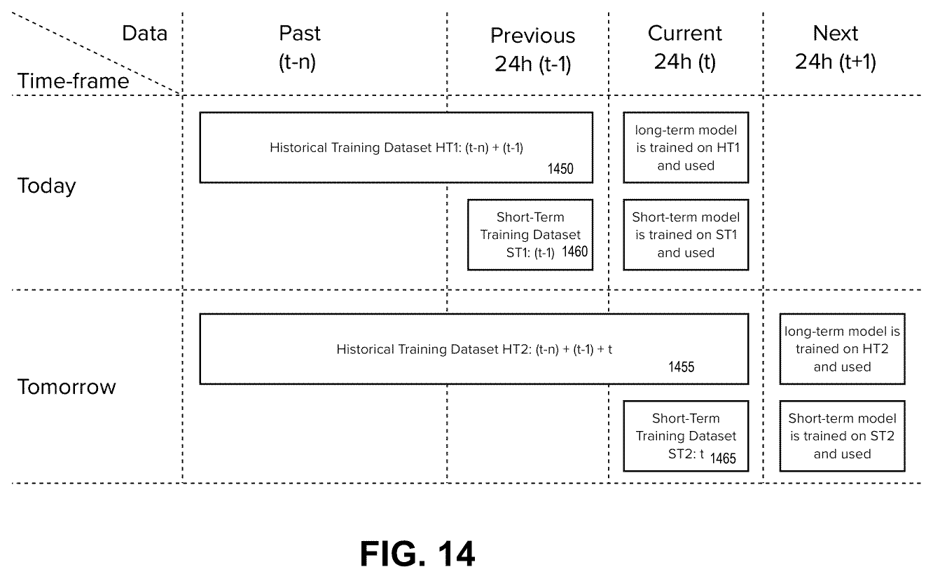

FIG. 14 depicts an example timeline for continuous updates of various ML models. As depicted, the x axis defines the temporal boundaries of the training data used, and the y axis defines the passage of time. For example, an entry in the graph which appears vertically lower should be understood to be occurring at a later point in time).

As depicted, on a current day, a long-term model 1450 may be trained using a combination of the historical data set HT1 (which extends n time periods into the past (t−n), and includes data ST1 from the previous time period (t−1) (e.g. the previous 24 hours), and the resulting model 1450 may be used on data received in the current 24 hour time period (t). At the same time, a short-term model 1460 may be trained based on the past 24 hour time period alone (t−1) (training dataset ST1), and used for the current 24 hour time period (t).

In the example depicted in FIG. 14, it will be understood that the example system is configured to update or re-train new models every 24 hour period. As such, on the day after the current day (depicted as ‘tomorrow’), a new long-term model 1455 may be trained using historical training data set HT2, which includes dataset HT1 (which includes (t−n), and (t−1)), plus the data from the past 24 hours (t) (i.e. the data which was the ‘current’ 24 hour data in the ‘today’ time-frame). Likewise, a new short-term model 1465 may be trained using training data set ST2 (t), which corresponds to the dataset from the ‘current’ 24 hour data window in the ‘today’ time-frame.

In some embodiments, the training of ML models may be incremental, with fine-tuning techniques being applied iteratively. In some embodiments, fine-tuning techniques may include the already pre-trained model trained using all historical data being loaded first, with other layers “frozen” (i.e., set as “untrainable” to retain the learned weights and biases), and the model may then be trained on only the last 24 hours of data. In some embodiments, the updated pre-trained historical models can be then used to train short-term and active-term models using the same or similar techniques. As previously described, all models may be replaced or are replaceable in real-time, without negatively affecting system performance.

Some embodiments may use a set of “base” datasets with a super-set of all features (e.g., attributes) available. From this base dataset, a more specific dataset may be derived for each ML model based on the goals and needs of each model. This derived, specialized dataset may then be used to train each ML model so as to be more tailored to a particular context. In some embodiments, the same or similar process may used during fine-tuning. One of the most significant differences between these datasets is that statistical, calculated, and aggregated values are all calculated using different time durations, different windows, and the like. For instance, when calculating rates over periods of times, these periods of time may be different, and may require synchronization in order to be optimized.

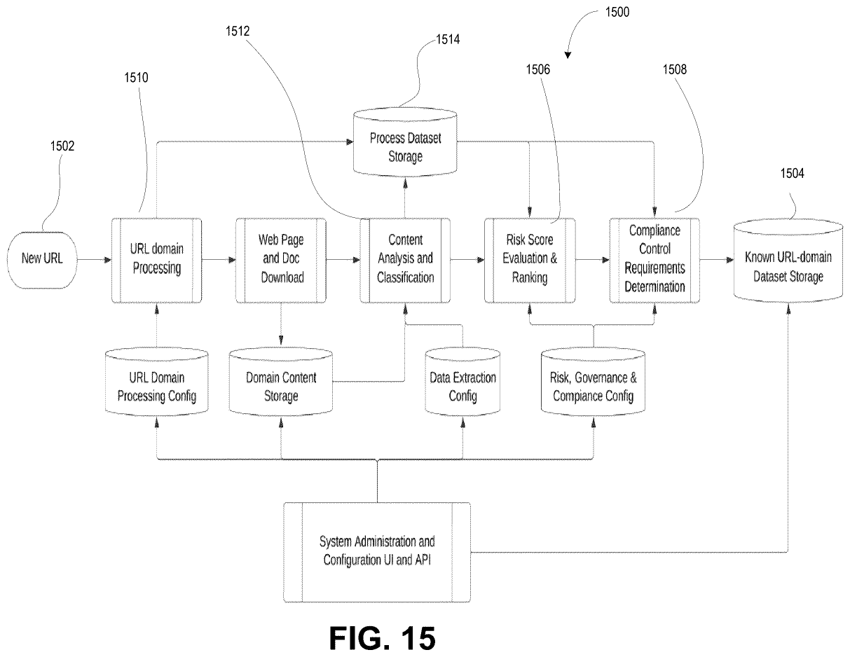

FIG. 15 depicts an example workflow for processing new (or previously unknown) sets of domains or URLs 1502, in accordance with some embodiments. In some embodiments, the process may be end-to-end and/or asynchronous (non-real-time, out-of-process). An unknown domain or URL may be, for example, a URL (e.g., rbc.com, rbc.ca, or the like) which is not previously known to system 500 and therefore not contained in the known URL-domain dataset 1504. In some embodiments, a set of domains and/or URLs may include one or more URLs.

In some embodiments, updating of the dataset for known URLs may be conducted periodically, based on configuration and calculated attributes of each set of related domains. It is contemplated that there may exist a set of related domains belonging to the same organization/publisher. In some embodiments these sets of related domains may be grouped together. In other embodiments, these sets of related domains may be separated for better granularity.

Some examples of Server Name Identification values may include “api.apple-cloudkit.com”, “firefox-settings-attachments.cdn.mozilla.net”, “res-1.cdn.office.net”, “incoming.telemetry.mozilla.org”, “static2.sharepointonline.com”, “login.microsoftonline.com”, “google.com”, “youtube.com”, “gemini.google.com”, and the like. The determination as to whether to put domains into a set or to keep the domains separated may be made based on one or more of the attributes of the domain, the total number of requests and/or other calculated attributes. In some embodiments, the determination can be changed during the update process for each domain.

From a high-level, if several domains share a common root, have the same risk profile, and/or map to the same governance and compliance controls, these domains may be suitable candidates for being put in a combined set. An example process for grouping domains into a combined set is described herein. Once the domain is in the system (i.e., stored in the “known URLs” data store 1504), the domain is referred to as a known URL-domain.

In some embodiments, a process similar to that depicted in the example process of FIG. 15 may be used to refresh and maintain data stores (databases) on a configuration-driven dynamic schedule.

In some embodiments, the result of the example process depicted in FIG. 15 may be a dataset with values for multiple attributes assigned to each domain, or to a set of domains if grouped. The dataset may contain many attributes (or features), including but not limited to multiple categories assigned as a result of many different classifications described herein and illustrated with respect to the Risk Score Evaluation & Ranking block 1506, and the Compliance Control Requirements Determination block 1508 of FIG. 15.

In some embodiments, these classes or categories may be calculated by ensembles of ML models trained to classify domains. For example, domains may be classified based on content (e.g., news, music, etc). Another example of a classification is based on the type of data that is collected (e.g., name, email, job-related data, and the like), and/or whether users can opt-in or opt-out of data collection, whether users can purge data, and the like. Still further examples include attributes such as requiring registration, requiring login, and the like.

In some embodiments, Natural Language Processing (NLP) may be used to recognize significant documents, such as Terms and Conditions, Privacy, Licensing, End User Agreements, Disclosures, and other similar documents. Such documents may be analyzed by a data extraction and evaluation system, to extract and evaluate data in order to assign appropriate calculated values when creating a dataset for each domain or set of domains. Based on this analysis, some embodiments of the system may be able to determine the necessary controls that need to be put in place for the corporate users attempting to reach such remote servers.

In some embodiments, these controls may be assigned by systems and methods described here. In some embodiments, when integrated with a Multi Layer Risk Mitigation system 600, the decision on which control to put in place may be determined dynamically at run-time, depending on the context of the TCP stream (i.e., connection).

In some embodiments, real-time risk scores generated by RECS 630 may be used by system 600 to retrieve the appropriate control, or a set of controls determined by systems and methods described herein based on the run-time risk levels of the active TCP steam. In some embodiments, this decision may be made using ML probabilistic models which allow for a greater flexibility and dimensionality. The use of ML probabilistic models may also lead to the decoupling of these two systems, and the datasets used by them can evolve as necessary.

In some embodiments, system administrators can assign specific domains and/or sets of domains (i.e., custom categories) manually. The system may also support retrieval of classification categories from other corporate systems. This integration may allow for applying specific governance and compliance controls based on internal corporate policies which may be defined in various other systems. It is likely that when organizations 10 conduct internal risk assessments and other due diligence, the organization 10 will have created datasets that can be mapped to URL-domains. Most large organizations keep track of various incidents, and can associate and/or attribute incidents to specific corporate assets and systems, including third party and/or SaaS applications. Some embodiments may perform automated mapping, and/or system administrators may be able to configure the system and/or directly define mappings.

During processing, some embodiments may retrieve data from these internal systems, refresh the data set, and recalculate the risk score ranges, and then assign the controls accordingly based on results. This functionality may also support continuous and/or automatic inclusion of the latest data from regular, periodic reviews of all contracts and agreements with 3rd parties which are commonly conducted by most organizations (and are often mandated to be performed by regulations in various jurisdictions).

Some embodiments may be capable of collecting data from third party providers of corporate surveys, which may focus on various aspects including security, financial, geographic, data leak, and/or other risks. Other examples may include the geographic location of the headquarters of an organization, registrations in various jurisdictions, and the like. Still further examples, specifically for SaaS applications, may include functionality offered, pricing models, corporate structure, and the like. Some embodiments may be able to collect and analyze this data using a system configuration that determines weights and biases assigned to each source of data, as well as the mapping between external data sources and datasets produced and used by some embodiments described herein. Due to the flexible, layered architecture, some embodiments described herein may be able to add and remove data sources without negatively affecting the system, and without requiring major integration efforts.

In some embodiments, all data obtained internally, as well as from third parties, may be processed, organized, and formatted into datasets to be used as input into ensembles of Machine Learning (ML) models that determine various risk classifications, and/or the overall risk classification for each domain or set of domains. In some embodiments, a goal for the dataset is to facilitate real-time network request evaluations, and/or provide set of controls based on governance and compliance requirements.

Some examples of these controls may include, for example, logging access, displaying informational or warning messages (e.g., “the external domain you are visiting collects data”, “do not provide any confidential or client personal information”, “the external domain you are visiting offers content”), or collecting consent from the user (e.g., “To proceed you must acknowledge this warning”). Some embodiments may aid with detecting domains offering SaaS products in order to control proliferation, prevent abuse, and/or limit the risks posed by third party SaaS applications. Some example risks may include, for example, data leakage, data sharing, and disclosure.

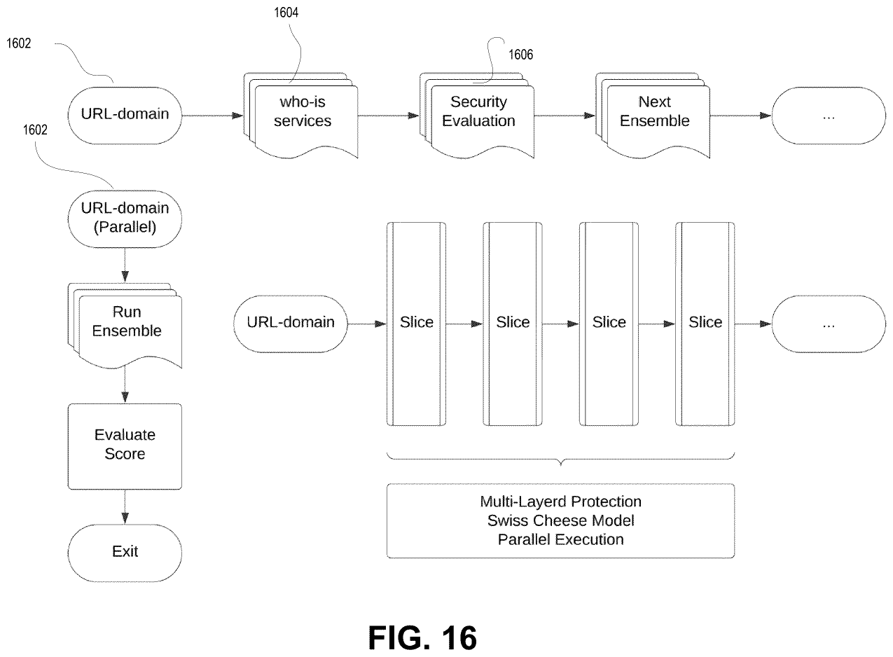

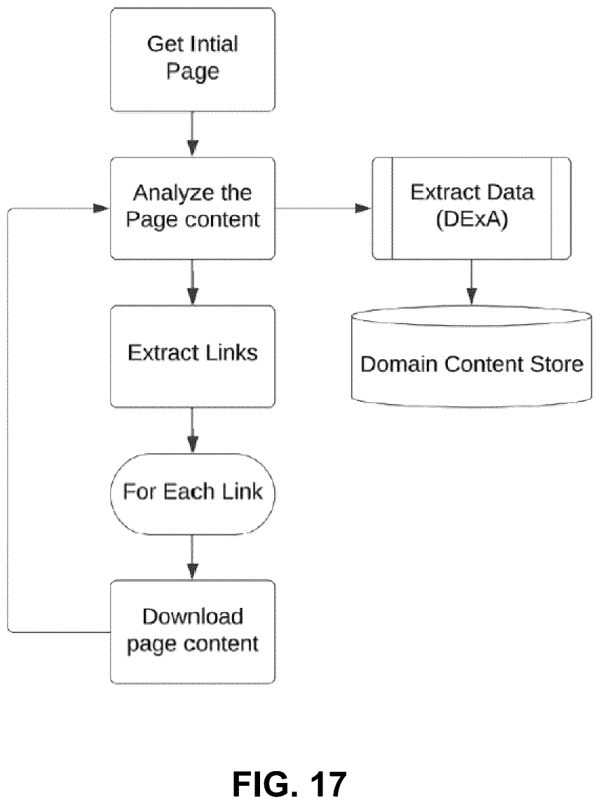

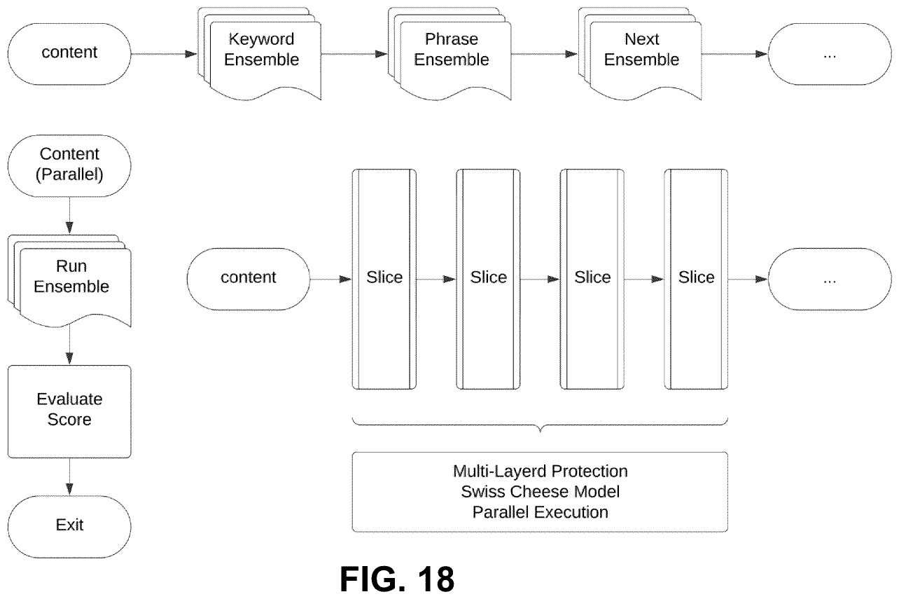

FIG. 16 depicts an example process of downloading and extracting relevant content from a URL-domain 1602 for further processing, as depicted at the URL Domain Processing block 1510 of FIG. 15. In some embodiments, this process 150 may be similar to a web crawler, but may differ in that the process described herein is fine-tuned and integrated into the system. FIG. 17 depicts an example process showing example operations for processing downloaded content. For example, the process may include initially loading the page from the URL, analyzing the page content, extracting any links, downloading the page content for each link, analyzing the page content for each link, and so on. Such content may be extracted and stored in a domain content data store.

Some embodiments are flexible, and third party components can be integrated to facilitate or help with the downloading of the content. In some embodiments, after the content is downloaded, a data extraction system might extract only the relevant data. An example data extraction system is disclosed, for example, in U.S. patent application Ser. No. 18/920,876, filed Oct. 19, 2024, the entire contents of which are incorporated herein by reference. In some embodiments, system administrators may be able to configure the data extraction system to, for example, extract Terms and Conditions, Privacy and other similar documents, and to find relevant clauses which may then be labelled and used by the system to assign class labels and calculate risk for the domain based on the presence or absence of specific labelled closes in these documents.

In some embodiments, in addition to the content visible to the user (i.e., the content that is displayed to the user through the user agent, such as a web browser), the downloaded content may also capture code such as HTML, JavaScript, and the like, which are referred to herein as “code and configuration” (CnC). CnC may also be captured analyzed, in some embodiments. Moreover, third party tools may be used to analyze downloaded content, which may offer greater flexibility at some cost.

In other embodiments, already-prepared third party data may be used as mentioned above. FIG. 16 depicts a simplified, high-level workflow for a content analysis and classification process 1512, and further examples are described in U.S. Provisional patent application Ser. No. 18/920,876 , filed Oct. 19, 2024.

In some embodiments, the output of the process 1512 depicted in FIG. 16 may be stored in Process Dataset Storage 1514. In some embodiments, this output is a comprehensive dataset. In some embodiments, the dataset may be a JSON formatted data structure. In other embodiments, the dataset may be any of a YAML, CSV, or XML data structure.

In some embodiments, attributes of this dataset may be any of values derived and calculated from a “who-is” service 1604, attributes from third party security descriptions 1606, evaluation values, and/or other attributes related to the content downloaded from the domain. Attributes may be in any suitable format, such as continuous numerical values, descriptive text, binary values, or categorical values.

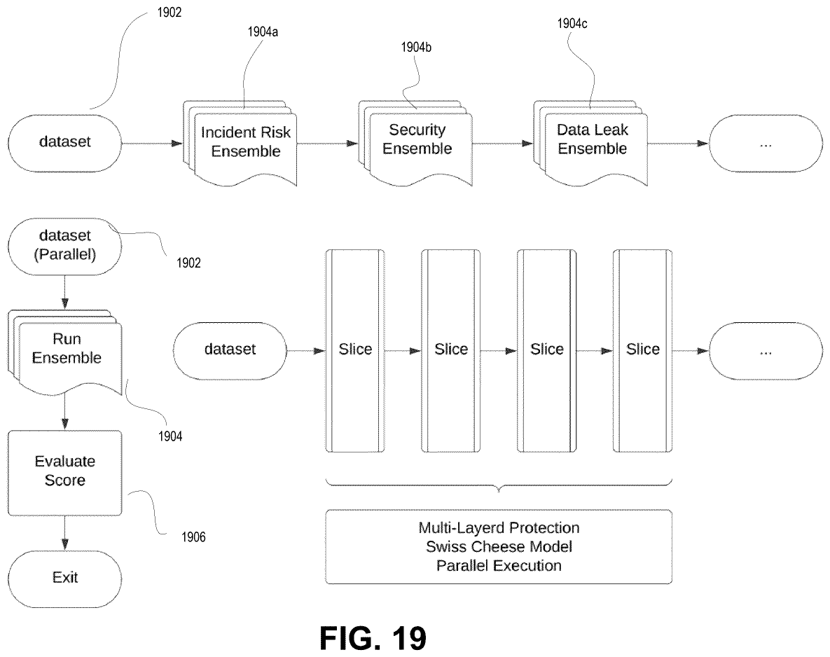

An example embodiment of the Risk Score Evaluation and Ranking block 1506 of system 1500 is illustrated in FIG. 19. As depicted, the risk score evaluation and ranking process may take a dataset 1902 and perform a series of data transformations specific to each ensemble which the block is configured to execute. In some embodiments, ensembles 1904 may be executed in parallel. In some embodiments, such data transformations may include one or more of normalization, scaling, feature engineering, and the like. Each dataset may be pre-processed according to the configuration, as well as according to the needs for a specific ensemble or set of related ensembles prior to running of the ensemble. In some embodiments, each of these operations may be conducted in parallel, with results forwarded directly by each process back to the Process Dataset Storage block 1514.

In some embodiments, the result of each ensemble is a series of scores 1906 scaled to a decimal value between 0 and 1. In some embodiments, this process may incorporate one or more aspects of a risk prediction system as disclosed, for example, in U.S. Provisional Patent Application No. 63/591,560 , filed Oct. 19, 2023, and U.S. patent application Ser. No. 18/920,869, the entire contents of both applications being incorporated by reference herein. In some embodiments, these scores 1906 may be used by the Compliance Control Requirements Determination block 1508 in FIG. 15 to determine the set of controls needed based on score ranges defined in the system configuration.

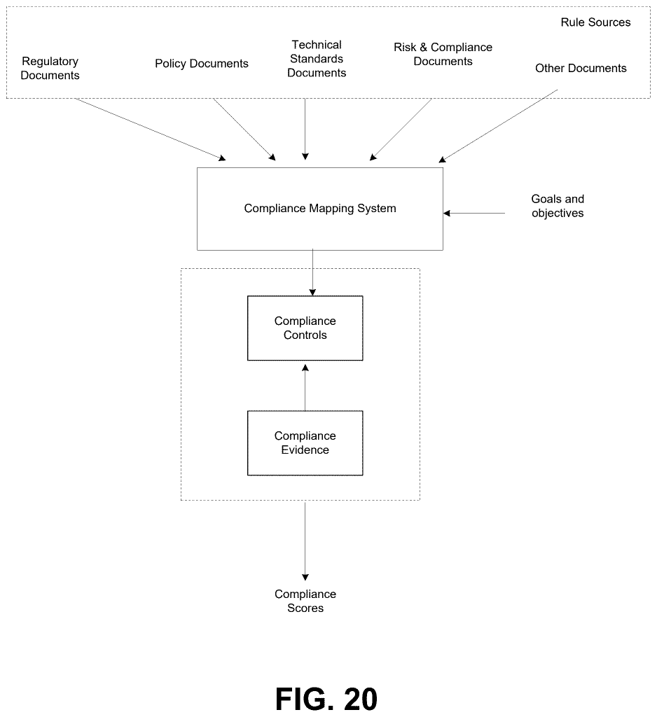

FIG. 20 depicts an example workflow for an example Compliance Control Requirements Determination block 1508 depicted in FIG. 15, in accordance with some embodiments. As depicted, a compliance control requirements determination block 1508 may include a compliance mapping system configured to generate compliance controls based on any of regulatory documents, policy documents, technical standards documents, risk & compliance documents, as well as goals and objectives. In some embodiments, the compliance control requirements determination block may incorporate one or more aspects from U.S. Provisional Patent Application No. 63/591,549, filed Oct. 19, 2023, and U.S. patent application Ser. No. 18/920,708, filed Oct. 18, 2024, the entire contents of both applications being incorporated herein by reference. In some embodiments, the mapping techniques described in the aforementioned incorporated references, and system described in this disclosure, may be combined to determine the appropriate set of applicable controls to associate with the URL-domain, or with a set of URL domains.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of providing a multi-layered protection and mitigation system, the method comprising:
receiving, within a private network, one or more network data packets comprising a request to access a resource external to said private network;
processing, by a risk exposure evaluation and mitigation subsystem within said private network, said one or more network packets to determine an anomaly score;
determining, by a risk exposure scoring subsystem within said private network, a risk score for one or more network data packets using one or more ensembles of ML models;
determining whether said one or more network data packets exhibits anomalous behavior based on said real-time risk score;
determining a mitigation action based on said real-time risk score;
implementing said mitigation action at a policy enforcement point within said private network.

2. The method of claim 1, wherein said one or more network data packets are TCP packets.

3. The method of claim 1, wherein said one or more network data packets comprise a stream of related network data packets.

4. The method of claim 3, wherein said stream is a TCP stream.

5. The method of claim 1, further comprising updating said real-time risk score based on a subsequently received network packet.

6. The method of claim 1, wherein said processing said one or more network packets to determine an anomaly score comprises processing said one or more network packets in real-time.

7. The method of claim 3, further comprising mapping said stream of network data packets to a user, a source of said network data packets, and a destination for said network data packets.

8. The method of claim 8, wherein said destination for said network data packets is external to said private network.

9. The method of claim 1, wherein said anomaly score is a value between 0 and 1.

10. The method of claim 1, wherein said mitigation action comprises an action selected from the group comprising: stop and hide, stop and warn, proceed and warn, proceed conditionally, proceed and log, and proceed.

11. The method of claim 1, wherein determining said mitigation action comprises comparing said real-time risk score to one or more threshold values delineating different risk levels.

12. The method of claim 1, further comprising providing an application programming interface (API) external to said private network, said API configured to request, from said resource external to said private network, external usage data for devices external to said private network.

13. The method of claim 12, further comprising combining said external usage data with usage data maintained internal to said private network to re-train one or more of said ML models.

14. The method of claim 12, wherein said external data comprises one or more of user identifiers and/or system identifiers.

15. The method of claim 14, wherein said system identifiers comprise a server name indication (SNI) identifier and/or a uniform resource locater (URL)-domain identifier.

16. The method of claim 13, wherein said re-training said one or more ML models is performed asynchronously.

17. A system, comprising:
one or more processors;
a non-transitory computer-readable storage medium having stored thereon processor-executable instructions that, when executed by said one or more processors, cause said one or more processors to perform a method of providing a multi-layered protection and mitigation system, the method comprising:
receiving, within a private network, one or more network data packets comprising a request to access a resource external to said private network;
processing, by a risk exposure evaluation and mitigation subsystem within said private network, said one or more network packets to determine an anomaly score;
determining, by a risk exposure scoring subsystem within said private network, a risk score for one or more network data packets using one or more ensembles of ML models;
determining whether said one or more network data packets exhibits anomalous behavior based on said real-time risk score;
determining a mitigation action based on said real-time risk score;
implementing said mitigation action at a policy enforcement point within said private network.

18. A non-transitory computer-readable storage medium having stored thereon processor-executable instructions that, when executed by one or more processors, cause the one or more processors to perform a method of providing a multi-layered protection and mitigation system, the method comprising:
receiving, within a private network, one or more network data packets comprising a request to access a resource external to said private network;
processing, by a risk exposure evaluation and mitigation subsystem within said private network, said one or more network packets to determine an anomaly score;
determining, by a risk exposure scoring subsystem within said private network, a risk score for one or more network data packets using one or more ensembles of ML models;
determining whether said one or more network data packets exhibits anomalous behavior based on said real-time risk score;
determining a mitigation action based on said real-time risk score;
implementing said mitigation action at a policy enforcement point within said private network.
